(19) United States
(12) Patent Application Publication
(10) Pub. No.: US 2011/0228844 A1
(43) Pub. Date: Sep. 22, 2011

(54) MOVING PICTURE ENCODING METHOD AND MOVING PICTURE DECODING METHOD

(76) Inventors: Takashi WATANABE, Fuchu-shi (JP); Goki Yasuda, Kawasaki-shi (JP); Naofumi Wada, Yokohama-shi (JP); Takeshi Chujoh, Kawasaki-shi (JP); Akiyuki Tanizawa, Kawasaki-shi (JP)

(21) Appl. No.: 13/151,311

(22) Filed: Jun. 2, 2011

Related U.S. Application Data
(63) Continuation of application No. PCT/JP2009/057220, filed on Apr. 8, 2009.

(30) Foreign Application Priority Data
Jan. 5, 2009 (JP) 2009-000027

(51) Int. Cl. H04N 7/26

(52) U.S. Cl. 375/240.03; 375/240.29; 375/240.16; 375/E07.189; 375/E07.114; 375/E07.034

(57) ABSTRACT

According to one embodiment, a moving picture encoding method includes deriving a target filter to be used for a decoded image of a target image to be encoded. The method includes setting a correspondence relationship between target filter coefficient in the target filter and reference filter coefficient in a reference filter in accordance with tap length of the target filter and tap length of the reference filter. The method includes deriving coefficient difference between the target filter coefficient and the reference filter coefficient in accordance with the correspondence relationship. The method includes encoding target filter information including the tap length of the target filter and the coefficient difference.

### CROSS REFERENCE TO RELATED APPLICATIONS

This is a Continuation Application of PCT Application No. PCT/JP2009/057220, filed Apr. 8, 2009, which was published under PCT Article 21(2) in Japanese.

This application is based upon and claims the benefit of priority from Japanese Patent Application No. 2009-000027, filed Jan. 5, 2009; the entire contents of which are incorporated herein by reference.

### FIELD

Embodiments described herein relate generally to a moving picture encoding method and a moving picture decoding method that make it possible to use a plurality of filters with different tap length selectively.

### BACKGROUND

A known moving picture encoding system, such as H. 264/AVC, encodes a coefficient obtained by applying orthogonal transform and quantization to a prediction error signal between an original image signal and a prediction image signal. In order to improve the image quality of a decoded image, which is obtained by decoding an image signal thus encoded, a filter process is performed on the encoding and/or decoding side.

A post-filter process described in, “Post-filter SEI message for 4:4:4 coding” by S. Wittmann and T. Wedi, JVT of ISO/IEC MPEG & ITU-T VCEG, JVT-S030, April 2006 (hereinafter, simply referred to as a reference document) is provided on the decoding side in order to improve the image quality of a decoded image. Specifically, filter information, such as filter coefficients in a post filter and a filter size (tap length) that are used on the decoding side, are set on the encoding side, then multiplexed into an encoded bit stream and output. On the decoding side, a post-filter process based on the filter information is performed on the decoded image signal. Accordingly, setting filter information so as to minimize errors between the original image signal and the decoded image signal on the encoding side enables the post-filter process to improve the image quality of a decoded image.

The post-filter process described in the reference document encodes filter information on the encoding side and transmits it to the decoding side. In this case, as the quantity of code generated based on the filter information increases, encoding efficiency on the encoding side decreases. Therefore, a method for reducing the quantity of code generated based on the filter information is required.

### BRIEF DESCRIPTION OF THE DRAWINGS

FIG. 1 is a block diagram of a moving picture encoding apparatus according to a first embodiment.

FIG. 2 is a block diagram of the inside of a filter difference information generating unit shown in FIG. 1.

FIG. 3 is a flowchart of a filter difference information generating process performed by the moving picture encoding apparatus shown in FIG. 1.

FIG. 4 is a block diagram of a moving picture decoding apparatus according to a second embodiment.

FIG. 5 is a block diagram of the inside of a filter information reconstruction unit shown in FIG. 4.

FIG. 6 is a flowchart of a filter information reconstruction process performed by the moving picture decoding apparatus shown in FIG. 4.

FIG. 7 is a block diagram of a moving picture encoding apparatus according to a third embodiment.

FIG. 8 is a block diagram of a moving picture decoding apparatus according to a fourth embodiment.

FIG. 9 is a block diagram of a moving picture decoding apparatus according to a fifth embodiment.

FIG. 10A is a diagram of an example of indices showing the filter coefficient positions and filter coefficient position correspondence relationships of a filter to be encoded.

FIG. 10B is a diagram of an example of indices showing the filter coefficient positions and filter coefficient position correspondence relationships of a reference filter.

FIG. 11 is a block diagram of a filter difference information generating unit in an encoding apparatus according to a sixth embodiment.

FIG. 12 is a diagram explaining an example of spatial prediction for filter coefficients.

FIG. 13 is a flowchart of a filter difference information generating process performed by a moving picture encoding apparatus according to the sixth embodiment.

FIG. 14 is a diagram of an example of a syntax structure of an encoding bit stream.

FIG. 15A is a diagram of an example of a description form of filter difference information.

FIG. 15B is a diagram of an example of a description form of the filter difference information.

FIG. 16 is a block diagram of a modified example of the filter difference information generating unit shown in FIG. 11.

FIG. 17 is a block diagram of a modified example of the filter difference information generating unit shown in FIG. 11.

FIG. 18 is a block diagram of a filter information reconstruction unit in a moving picture decoding apparatus according to a seventh embodiment.

FIG. 19 is a flowchart of a filter information reconstruction process performed by a moving picture decoding apparatus according to the seventh embodiment.

FIG. 20 is a block diagram of a modified example of a filter information reconstruction unit shown in FIG. 18.

FIG. 21 is a block diagram of a modified example of the filter information reconstruction unit shown in FIG. 18.

FIG. 22 is a diagram of an example of a description form of filter difference information.

FIG. 23A is a diagram illustrating an example of spatial prediction for filter coefficients.

FIG. 23B is a diagram illustrating an example of spatial prediction for filter coefficients.

### DETAILED DESCRIPTION

Embodiments will hereinafter be described with reference to the accompanying drawings.

In general, according to one embodiment, a moving picture encoding method includes deriving a target filter to be used for a decoded image of a target image to be encoded. The method includes setting a correspondence relationship between a target filter coefficient in the target filter and a reference filter coefficient in a reference filter in accordance with tap length of the target filter and tap length of the reference filter. The method includes deriving a coefficient difference between the target filter coefficient and the reference filter coefficient in accordance with the correspondence relationship. The method includes encoding target filter information including the tap length of the target filter and the coefficient difference.

### First Embodiment

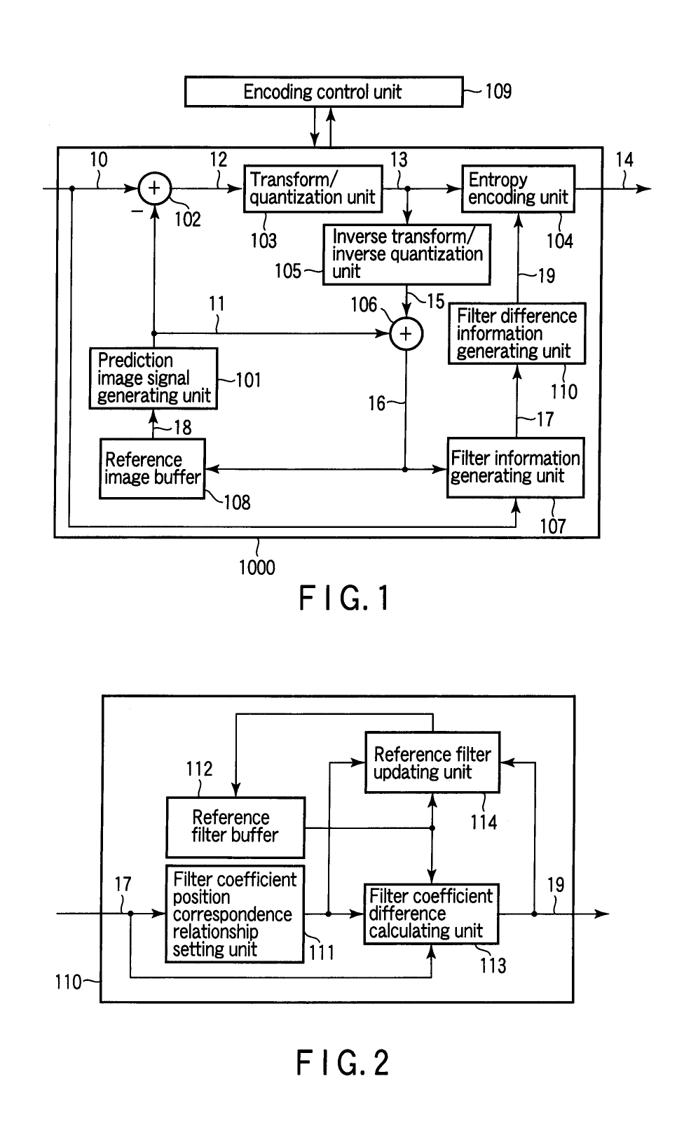

FIG. 1 shows a moving picture encoding apparatus according to a first embodiment. The moving picture encoding apparatus carries out so-called hybrid encoding, and includes a moving picture encoding unit 1000 and an encoding control unit 109. The moving picture encoding unit 1000 includes a prediction image signal generating unit 101, a subtractor 102, a transform/quantization unit 103, an entropy encoding unit 104, an inverse transform/inverse quantization unit 105, an adder 106, a filter information generating unit 107, a reference image buffer 108, and a filter difference information generating unit 110. The encoding control unit 109 controls the entire moving picture encoding unit 1000, such as feedback control of the quantity of generated code, control of quantization, control of prediction mode and control of motion prediction accuracy.

The prediction image signal generating unit 101 predicts an input image signal (an original image signal) 10 per block and generates a prediction signal 11. Specifically, the prediction image signal generating unit 101 reads an encoded reference image signal 18 from a reference image buffer 108 (described below), and detects a motion vector indicating the motion of the input image signal 10 relative to the reference image signal 18. The motion vector is detected by, for example, block matching. The prediction image signal generating unit 101 supplies the subtractor 102 and adder 106 with a prediction image signal 11 predicted from the reference image signal 18 by means of the motion vector mentioned above. Instead of the motion compensation prediction (a prediction in the direction of temporal), the prediction image signal generating unit 101 may carry out intra prediction (prediction in the direction of spatial) to generate the prediction image signal 11.

The subtractor 102 subtracts the prediction image signal 11 supplied by the prediction image signal generating unit 101 from the input image signal 10, thereby obtaining an prediction error signal 12. The subtractor 102 inputs the prediction error signal 12 into the transform/quantization unit 103.

The transform/quantization unit 103 orthogonally transforms the prediction error signal 12 from the subtractor 102, thereby obtaining a transform coefficient. For example, a Discrete Cosine Transform (DCT) may be used as the orthogonal transform. Incidentally, the transform/quantization unit 103 may perform other transform processes such as wavelet transform, independent component analysis, or Hadamard transform. The transform/quantization unit 103 quantizes the transform coefficient according to quantization parameter (QP) set by the encoding control unit 109. The quantized transform coefficient (hereinafter referred to as “quantized transform coefficient 13”) is input to the entropy encoding unit 104 and the inverse-transform/inverse-quantization unit 105.

The entropy encoding unit 104 entropy codes a quantized transform coefficient 13 supplied by the transform/quantization unit 103, and coding parameters, thereby obtaining encoded data 14. For example, Huffman coding or arithmetic coding may be used as entropy coding. The coding parameters include filter difference information 19 supplied by the filter difference information generating unit 110, described below. The coding parameters may include prediction mode information indicating a prediction mode for a prediction image signal 11, block size switching information, and quantization parameters. The entropy encoding unit 104 outputs an encoded bit stream obtained by multiplexing the encoded data 14.

In accordance with quantization parameters, the inverse transform/inverse quantization unit 105 inversely quantizes the quantized transform coefficient 13 supplied by the transform/quantization unit 103, and thereby decodes the transform coefficient. For the decoded transform coefficient, the inverse transform/inverse quantization unit 105 decodes the prediction error signal 12 by performing inverse transform of the transform process performed by the transform/quantization unit 103. The inverse transform/inverse quantization unit 105 performs, for example, Inverse Discrete Cosine Transform (IDCT) or inverse wavelet transform. The inverse transform/inverse quantization unit 105 inputs the decoded prediction error signal (hereinafter referred to as “decoded prediction error signal 15”) into the adder 106.

The adder 106 adds the decoded prediction error signal 15 from the inverse transform/inverse quantization unit 105 and the prediction image signal 11 from the prediction image generating unit 101, thereby generating a locally decoded image signal 16. The adder 106 inputs the locally decoded image signal 16 into the filter information generating unit 107 and reference image buffer 108.

Based on the input image signal 10 and the locally decoded image signal 16 from the adder 106, the filter information generating unit 107 generates filter information 17 for a filter to be encoded. The filter information 17 includes switching information about whether to use a filter process on a decoded image signal corresponding to the input image signal 10 on the decoding side. If the switching information has a value indicating use of the filter process, the filter information 17 further includes information specifying the filter to be used (the filter to be encoded). Specifically, tap length information concerning tap length of the filter and filter coefficients are further included. Determined for use as filter coefficients are: for example, coefficient values for minimizing error between the locally decoded image signal 16 (which corresponds to a decoded image signal on the decoding side) and the input image signal 10; and coefficient positions where the corresponding coefficient values are used respectively. Incidentally, instead of the locally decoded image signal 16, the filter information generating unit 107 may use an image signal obtained by performing a deblocking filter process for the locally decoded image signal 16. That is, a deblocking filter may be provided between the adder 106 and the filter information generating unit 107.

The reference image buffer 108 stores, as a reference image signal 18, the locally decoded image signal 16 output from the adder 106. The prediction image signal generating unit 101 reads this signal 16 as necessary.

The filter difference information generating unit 110 stores reference filter information including tap length information and filter coefficients in a reference filter described below. The filter difference information generating unit 110 generates filter difference information 19, which is about the difference between the reference filter information and the filter information 17. The filter difference information generating unit 110 inputs the filter difference information 19 into the entropy encoding unit 104.

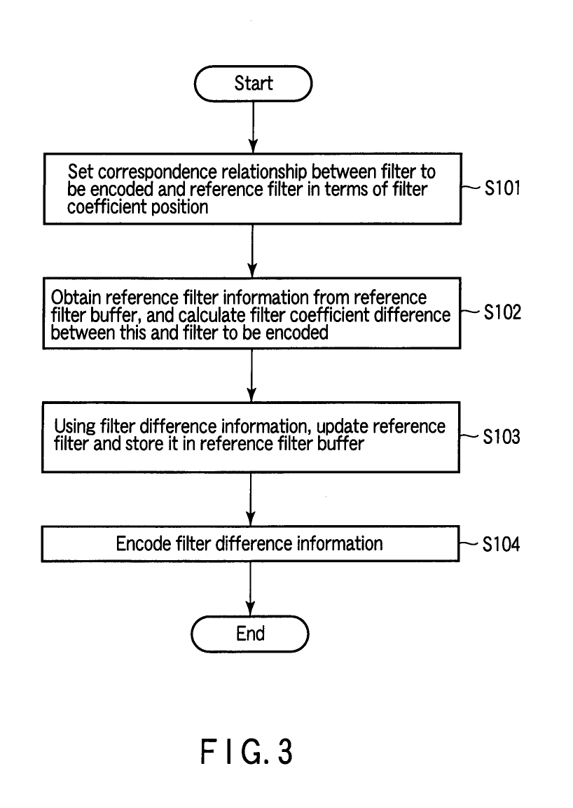

The internal portion of the filter difference information generating unit 110 will now be described with reference to FIG. 2.

As shown in FIG. 2, the filter difference information generating unit 110 includes a filter coefficient position correspondence relationship setting unit 111, a reference filter buffer 112, a filter coefficient difference calculating unit 113, and a reference filter updating unit 114.

The filter coefficient correspondence relationship setting unit 111 sets a correspondence relationship between the filter information 17 and reference filter information in terms of the filter coefficient position. Both the filter information 17 and reference filter information include tap length information and filter coefficients. The tap length of a filter to be encoded is not always equal to that of the reference filter. Even when the tap length of an encoded filter is not equal to that of the reference filter, the filter coefficient position correspondence relationship setting unit 111 associates the filter coefficient positions of the filter information 17 with the corresponding filter coefficient positions of the reference filter information respectively. For example, the filter coefficient position correspondence relationship setting unit 111 associates filter coefficient positions of the filter information 17 with the corresponding filter coefficient positions of the reference filter information so that the central position of the filter coefficients in the filter information 17 coincides with the central position of the filter coefficients in the reference information. The filter coefficient position correspondence relationship setting unit 111 informs the filter coefficient difference calculating unit 113 and the reference filter updating unit 114 of this correspondence relationship.

The reference filter buffer 112 temporarily stores reference filter information. The reference filter information is read by the filter coefficient difference calculating unit 113 as necessary.

The filter coefficient difference calculating unit 113 reads the reference filter information from the reference filter buffer 112. In accordance with the correspondence relationship determined by the filter coefficient position correspondence relationship setting unit 111, the filter coefficient difference calculating unit 113 subtracts each filter coefficient in the reference filter information from the corresponding filter coefficient in the filter information 17, thereby calculating filter coefficients differences. The filter coefficient difference calculating unit 113 replaces the filter coefficients in the filter information 17 with the filter coefficients differences, and inputs this difference into the entropy encoding unit 104 and reference filter updating unit 114 as filter difference information 19. The closer the characteristics of the reference filter is to the characteristics of the filter to be encoded, the smaller the filter coefficients differences become, making it possible to reduce the quantity of code.

In accordance with the correspondence relationship determined by the filter coefficient position correspondence relationship setting unit 111, the reference filter updating unit 114 adds the filter coefficients differences of the filter difference information 19 output from the filter coefficient difference calculating unit 113, to the filter coefficients in the reference filter information stored in the reference filter buffer 112. Thereby the reference filter updating unit 114 updates the reference filter information. In this case, the reference filter information may be updated each time the filter difference information 19 is generated or may be updated at predetermined timing. Alternatively, it may not be updated at all. Where the reference filter information is not updated at all, a reference filter updating unit 114 need not be provided. As an initial value for the filter coefficient in the reference filter information, a common value is used on the encoding and decoding sides. The reference filter information is updated at common timing on the encoding and decoding sides.

Referring to FIG. 3, the process of generating filter difference information 19 will now be described.

First, as an introduction, filter information 17 generated by the filter information generating unit 107 will be described in detail. In the description below, a filter information generating unit 107 deals with a two-dimensional Wiener filter generally used in image reconstruction, and a tap length is either 5×5 or 7×7.

The filter information generating unit 107 sets tap length to 5×5, and derives filter coefficients where a mean square error between an image signal in which the locally decoded image signal 16 is subjected to a filter process, and the input signal 10, is smallest. In addition, the filter information generating unit 107 sets a tap length of 7×7, and derives filter coefficients where the mean square error between an image signal in which the locally decoded image signal 16 is subjected to a filter process, and the input signal 10 is smallest. In accordance with the following expression (1), the filter information generating unit 107 derives a first encoding cost where the tap length is set to 5×5, a second encoding cost where the tap length is set to 7×7, and a third encoding cost where filter process is not performed.

cost=D+λ×R (1)

In the Expression 1, cost represents encoding cost, D represents the Sum of Squared Difference (SSD), λ represents a coefficient, and R represents the quantity of code generated.

If the first encoding cost is the smallest, the filter information generating unit 107 generates the filter information 17 including (A) switching information indicating that filter process is used, (B) tap length information indicating that the tap length is 5×5, and (C) the derived filter coefficient. If the second encoding cost is the smallest, the filter information generating unit 107 generates the filter information 17 including (A) switching information indicating that the filter process is used, (B) tap length information indicating that tap length is 7×7, and (C) the derived filter coefficient. If the third encoding cost is the smallest, the filter information generating unit 107 generates the filter information 17 including (A) switching information indicating that a filter process is not used.

The foregoing description has used an example where the filter information generating unit 107 derives the encoding costs. However, the encoding costs may be derived by the filter information generating unit 110. Specifically, the filter information generating unit 107 may input the filter information 17 where a filter process is not used, the filter information 17 where the tap length is 5×5, and the filter information 17 where the tap length is 7×7 into the filter difference information generating unit 110. Then, the filter difference information generating unit 110 may derive the three encoding costs by using the filter difference information 19 based on the three pieces of the filter information 17, and output filter difference information 19 with the smallest encoding cost. The entropy encoding unit 104 does not encode the filter information 17 but encodes this filter difference information 19. Accordingly, deriving encoding costs by using the filter difference information 19 results in more accurate values.

When the filter information generating unit 107 generates filter information 17 as described above, the tap length for the reference filter is the maximum tap length (=7×7) that can be included in the filter information 17. The initial value of the filter coefficient in the reference filter information may be an arbitrary value (e.g., a value derived statistically), but a common value is used on the encoding and decoding sides, as described above.

When the filter information generating unit 107 inputs the filter information 17 into the filter difference information generating unit 110, the process illustrated in FIG. 3 is started.

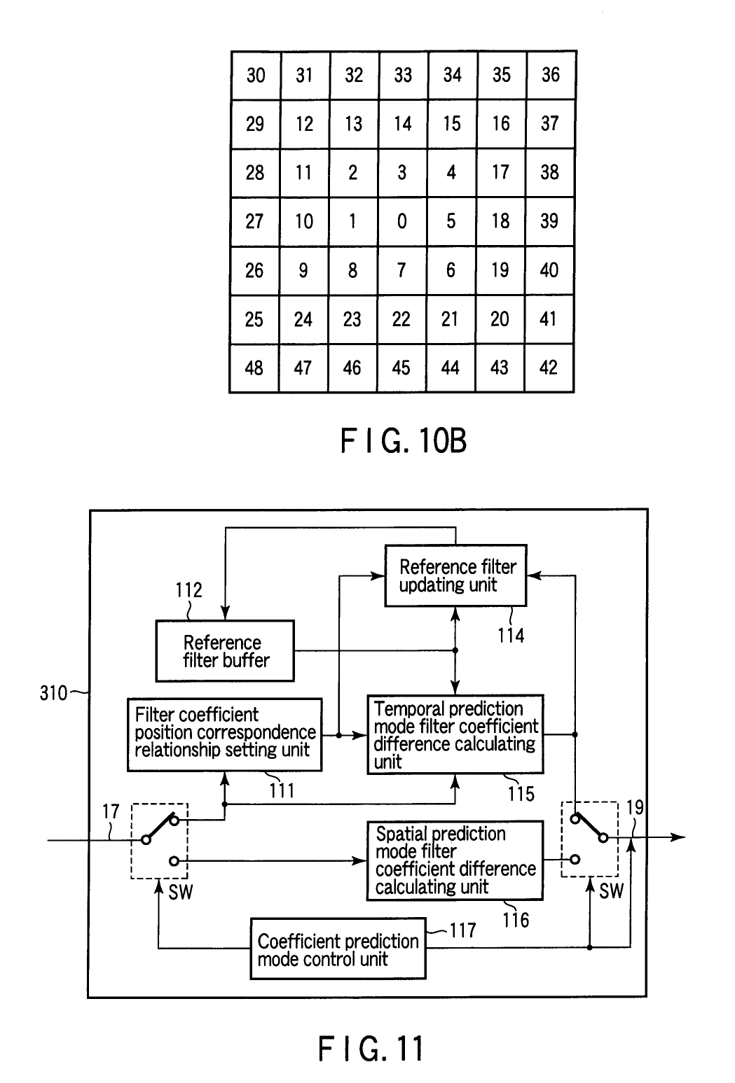

First, the filter coefficient position correspondence relationship setting unit 111 obtains the tap length of a filter to be encoded, which is specified by the filter information 17 supplied by the filter information generating unit 107; and then sets a correspondence relationship between the filter to be encoded and a reference filter in terms of the filter coefficient position (step S101). As described above, the tap length of the reference filter is 7×7 (refer to, for example, FIG. 10B). Therefore, if the tap length of the filter to be encoded is also 7×7, the filter coefficients in the filter to be encoded and the filter coefficients in the reference filter are associated in the same positions, one to one. On the other hand, if the tap length of the filter to be encoded is 5×5 (refer to, for example, FIG. 10A), the filter coefficient correspondence relationship setting unit 111 sets the correspondence relationship so that the central position (the position of index 0 in FIG. 10A) of the filter coefficients in the filter to be encoded coincides with the central position (the position of index 0 in FIG. 10B) of the filter coefficients in the reference filter. In other words, the filter coefficient position correspondence relationship setting unit 111 converts each of the filter coefficient positions of the filter to be encoded, to a first relative position from the center while converting each of the filter coefficient positions of the reference filter to a second relative position from the center. Thereby the filter coefficient position correspondence relationship setting unit 111 sets a correspondence relationship such that the first and second relative positions coincide. The filter coefficient position correspondence relationship setting unit 111 then informs the filter coefficient difference calculating unit 113 and reference filter updating unit 114 of this correspondence relationship. In the examples in FIGS. 10A and 10B, the indices show the correspondence relationships between the filter coefficients, that is, the filter coefficients at which the indices in FIG. 10A and those in FIG. 10B match are associated.

Next, the filter coefficient difference calculating unit 113 reads reference filter information from the reference filter buffer 112 and, in accordance with the correspondence relationship set in step S101, subtracts each filter coefficient in the reference filter information from the corresponding filter coefficient in the filter information 17, thereby calculating filter coefficients differences (step S102). The filter coefficients differences calculating unit 113 replaces the filter coefficients in filter information 17 with this filter coefficients differences, and outputs the filter coefficients differences to the entropy encoding unit 104 and reference filter updating unit 114 as the filter difference information 19.

Subsequently, in accordance with the correspondence relationship set in step S101, the reference filter updating unit 114 adds the filter coefficient difference calculated in step S102 to the filter coefficient included in the reference filter information stored in the reference filter buffer 112, thereby updating the reference filter information (step S103). As described above, updating the reference filter information is not an essential process. However, even when the characteristics of the filter to be encoded gradually change, updating the reference filter information enables the characteristics of the reference filter to follow changes in the characteristics of the filter to be encoded. Accordingly, increases in coefficients differences and hence the quantity of code generated can be suppressed.

Next, the entropy encoding unit 104 performs entropy encoding such as Huffman coding or arithmetic coding with respect to the filter difference information 19, generated in step S103, other coding parameters, and the quantized transform coefficients 13 (step S104). The entropy encoding unit 104 outputs an encoded bit stream obtained by multiplexing the encoded data 14, and then the process terminates.

As described above, the moving picture encoding apparatus according to the present embodiment prepares a reference filter, determines a correspondence relationship between a filter to be encoded and the reference filter in terms of filter coefficient positions, thereby calculating the coefficient differences between them, and encodes filter difference information including the coefficient differences instead of the filter information. Accordingly, even where the tap length of a filter to be encoded and that of a reference filter differ, the moving picture encoding apparatus according to the present embodiment can calculate a coefficient difference, and generate filter difference information that is smaller in quantity of code than the filter information.

The foregoing description was given using an example using only one piece of reference filter information. However, there may be more than one piece of reference filter information. For example, at least one of the properties (e.g., filter characteristics or tap length) of a filter to be encoded and the properties (e.g., slice type or quantization parameters) of an area where the filter to be encoded is used, may be set as a condition or conditions, and one of these may be selected for use from a plurality of pieces of reference filter information. By adaptively selecting the reference filter according to the condition, coefficient differences can easily be minimized. In addition, where a plurality of pieces of reference filter information are used, reference filter information that is independent from the condition mentioned above may be further provided. Filter coefficients included in reference filter information that is independent from the above-mentioned condition may be commonly used as an initial value for filter coefficients included in reference filter information that is dependent on the condition. This makes it possible to minimize coefficient differences even when reference filter information dependent on the condition is used for the first time.

### Second Embodiment

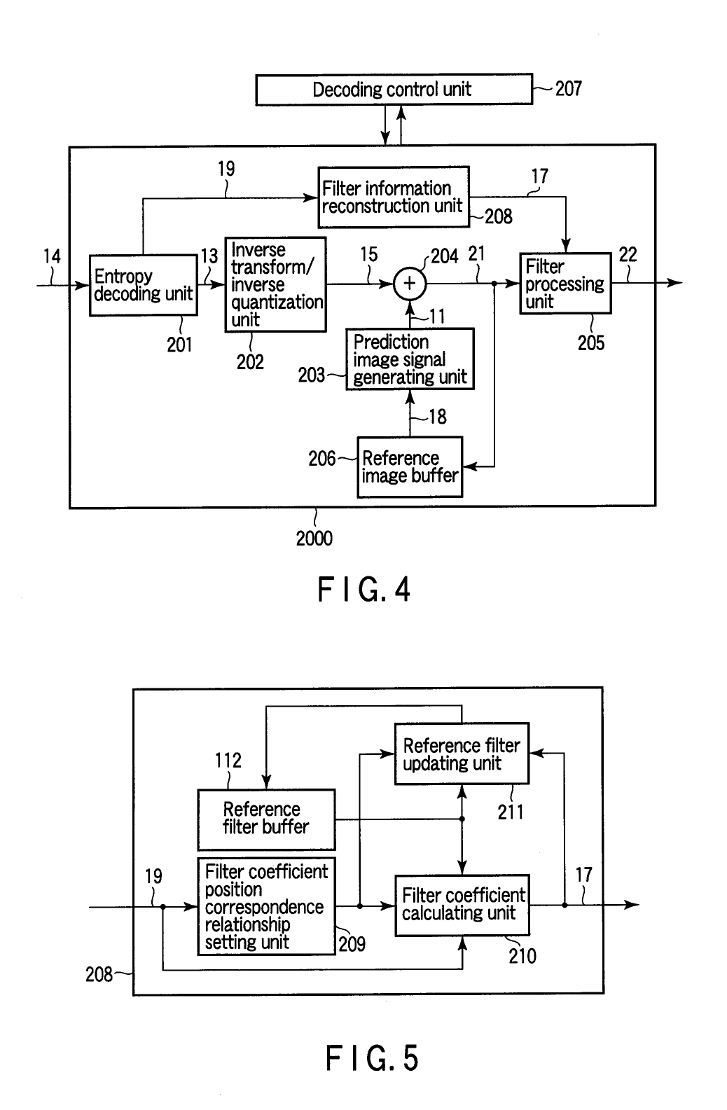

FIG. 4 shows a moving picture decoding apparatus according to a second embodiment. This moving picture decoding apparatus decodes coded data output from the moving picture encoding apparatus shown in FIG. 1. The moving picture decoding apparatus in FIG. 4 includes a moving picture decoding unit 2000 and a decoding control unit 207. The moving picture decoding unit 2000 includes an entropy decoding unit 201, an inverse transform/inverse quantization unit 202, a prediction image signal generating unit 203, an adder 204, a filter processing unit 205, a reference image buffer 206, and a filter information reconstruction unit 208. The decoding control unit 207 controls the entire decoding unit 2000 (e.g., control of decoding timing). In the description below, parts in FIG. 4 identical to those in FIG. 1 are labeled with identical numbers, and descriptions are principally of the different parts.

In accordance with predetermined syntax structure, the entropy decoding unit 201 decodes syntax code strings included in the encoded data 14. Specifically, the entropy decoding unit 201 decodes the quantized transform coefficient 13, the filter difference information 19, motion information, prediction mode information, block size switch information, quantization parameters, and etc. The entropy decoding unit 201 inputs the quantized transform coefficient 13 into the inverse transform/inverse quantization unit 202 and inputs the filter difference information 19 into the filter information reconstruction unit 208.

In accordance with the quantization parameters, the inverse transform/inverse quantization unit 202 inversely quantizes the quantized transform coefficient 13 output from the entropy decoding unit 201, and thereby decodes the transform coefficient. For the decoded transform coefficient, the inverse quantization/inverse transform unit 202 performs inverse transform of the process performed on the encoding side, and thereby decodes a prediction error signal. The inverse quantization/inverse transform unit 202 performs, for example, IDCT or inverse wavelet transform. The decoded prediction error signal (hereinafter referred to as “decoded prediction error signal 15”) is input into the adder 204.

The prediction image signal generating unit 203 generates a prediction image signal 11 identical or similar to that on the encoding side. Specifically, the prediction image signal generating unit 203 reads a decoded reference image signal 18 from the reference image buffer 206 (described below) and performs motion compensated prediction by use of motion information output from the entropy decoding unit 201. If a prediction image signal 11 has been generated by another prediction scheme on the encoding side, such as intra prediction, the prediction image signal generating unit 203 performs corresponding prediction, thereby generating a prediction image signal 11. The prediction image generating unit 203 inputs the prediction image signal 11 into the adder 204.

The adder 204 adds the decoded prediction error signal 15 from the inverse transform/inverse quantization unit 202 to the prediction image signal 11 from the prediction image signal generating unit 203, and thereby generates a decoded image signal 21. The adder 204 inputs the decoded image signal 21 into the filter processing unit 205. The adder 204 also inputs the decoded image signal 21 into the reference image buffer 206.

In accordance with filter information 17 from the filter information reconstruction unit 208 (described below), the filter processing unit 205 performs a predetermined filter process for the decoded image signal 21, thereby generating a reconstructed image signal 22. The filter processing unit 205 then outputs the reconstructed image signal 22 to the outside. Incidentally, instead of the decoded image signal 21, the filter processing unit 205 may use an image signal obtained by performing a deblocking filter process for the decoded image signal 21. That is, a deblocking filter may be provided between the adder 204 and the filter processing unit 205.

The decoded image signal 21 from the adder 204 is temporarily stored as a reference image signal 18 in the reference image buffer 206, and is read by the prediction image signal generating unit 203 as necessary.

As described below, using both reference filter information identical to that on the encoding side and the filter difference information 19 from the entropy decoding unit 201, the filter information reconstruction unit 208 reconstructs the filter information 17 (filter information of the filter to be decoded) generated on the encoding side. The filter information reconstruction unit 208 inputs the filter information 17 to the filter processing unit 205.

Referring to FIG. 5, the internal portion of the filter information reconstruction unit 208 will now be described.

As shown in FIG. 5, the filter information reconstruction unit 208 includes a filter coefficient position correspondence relationship setting unit 209, a filter coefficient calculating unit 210, a reference filter updating unit 211, and a reference filter buffer 112.

The filter coefficient position correspondence relationship setting unit 209 sets a correspondence relationship between the filter difference information 19 and reference filter information in terms of the filter coefficient positions. As described above, the filter difference information 19 and the filter information 17 differ from each other in terms of filter coefficient values but share other respects in common, including the filter coefficient positions. Therefore, the filter coefficient position correspondence relationship setting unit 209 may be identical in configuration to the filter coefficient position correspondence relationship setting unit 111 described above. For example, the filter coefficient position correspondence relationship setting unit 209 associates coefficient positions in the filter difference information 19 with the corresponding coefficient positions in the reference filter information so that the central position of the filter coefficients in the filter difference information 19 coincides with the central position of the filter coefficients in the reference information. The filter coefficient position correspondence relationship setting unit 209 informs a filter coefficient calculating unit 210 and a reference filter updating unit 211 of this correspondence relationship.

The filter coefficient calculating unit 210 reads reference filter information from the reference filter buffer 112. In accordance with the correspondence relationship determined by the filter coefficient position correspondence relationship setting unit 209, the filter coefficient calculating unit 210 adds filter coefficients included in the filter difference information 19 to corresponding filter coefficients included in the reference filter information. As described above, each filter coefficient included in the filter difference information 19 is obtained by subtracting filter coefficients included in the reference filter information from the corresponding filter coefficient included in the filter information 17 generated on the encoding side. Therefore, by adding filter coefficients in the filter difference information 19 to the corresponding filter coefficients in the reference filter information, each filter coefficient in the filter information 17 can be reconstructed. The filter coefficient calculating unit 210 replaces each filter coefficients in the filter difference information 19 with the corresponding reconstructed filter coefficients, and outputs this replaced coefficients as the filter information 17.

In accordance with the correspondence relationship determined by the filter coefficient position correspondence relationship setting unit 210, the reference filter updating unit 211 replaces each filter coefficients in the reference filter information stored in the reference filter buffer 112 with the corresponding filter coefficients in the filter information 17 output from the filter coefficient calculating unit 210 (with filter coefficients calculated by the filter coefficient calculating unit 210). Thus, the reference filter updating unit 211 updates the reference filter information. In this case, the initial value of the reference filter information and updating timing thereof are identical to those on the encoding side.

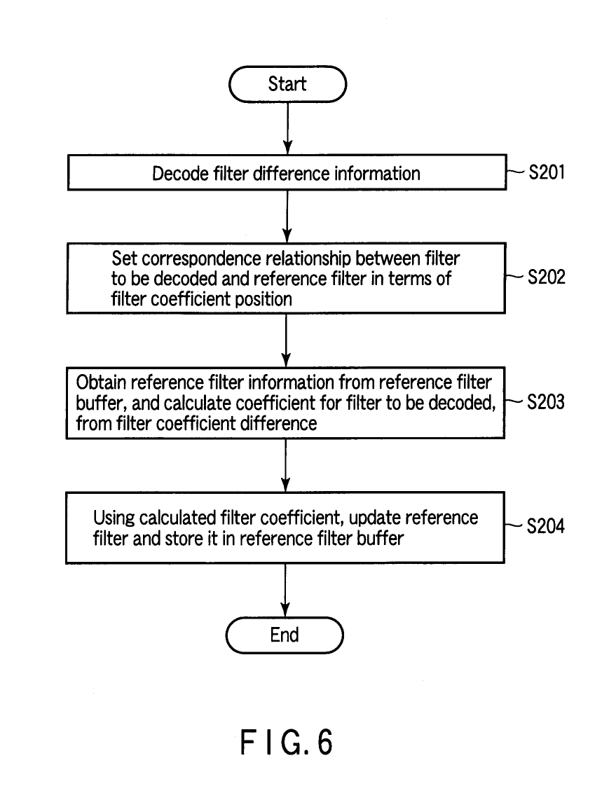

A decoding process for filter information 17 will now be described with reference to FIG. 6.

The process in FIG. 6 is started by the input of the encoded data 14 from the encoding side.

First, the entropy decoding unit 201 decodes the encoded data 14, and obtains the filter difference information 19 and other coding parameters, and the quantized transform coefficient 13 (step S201). The entropy decoding unit 201 inputs the quantized transform coefficient 13 into the inverse transform/inverse quantization unit 202 and input the filter difference information 19 into the filter information reconstruction unit 208.

Subsequently, the filter coefficient position correspondence relationship setting unit 209 obtains the tap length included in the filter difference information 19 output from the entropy decoding unit 201, and sets a correspondence relationship between the filter to be decoded and a reference filter in terms of filter coefficient positions (Step S202). As described above, the tap length of the reference filter information is 7×7. Therefore, if the tap length of the filter difference information 19 is also 7×7, the filter coefficients in the filter to be decoded and the filter coefficients in the reference filter are associated in the same positions, one to one. On the other hand, if the tap length of the filter difference information 19 is 5×5, the filter coefficient position correspondence relationship setting unit 209 sets the correspondence relationship so that the central position of the filter coefficients in the filter to be decoded coincide with the central position of the filter coefficients in the reference filter. In other words, the filter coefficient position correspondence relationship setting unit 209 converts each of the filter coefficient positions of the filter to be decoded to a first relative position from the center while converting each of the filter coefficient positions of the reference filter to a second relative position from the center. Thereby the filter coefficient position correspondence relationship setting unit 209 sets the correspondence relationship so that the first and second relative positions coincide. The filter coefficient position correspondence relationship setting unit 209 informs the filter coefficient difference unit 210 and reference filter updating unit 211 of this correspondence relationship.

Next, the filter coefficient calculating unit 210 reads reference filter information from the reference filter buffer 112 and, in accordance with the correspondence relationship set in step S202, adds each filter coefficient in the filter difference information 19 and the corresponding filter coefficient in the reference filter information, thereby reconstructing the filter coefficient included in the filter information 17 generated on the encoding side (step S203). The filter coefficient calculating unit 210 replaces the filter coefficients in the filter difference information 19 with the filter coefficients thus calculated, and inputs the replaced filter coefficients to the filter processing unit 205 and the reference filter updating unit 211 as the filter information 17.

Subsequently, in accordance with the correspondence relationship set in step S202, the reference filter updating unit 211 replaces the filter coefficients in the reference filter information stored in the reference filter buffer 112 with the filter coefficients calculated in step S203, thereby updating the reference filter information (step S204). As described above, updating the reference filter information is not an essential process. However, the timing of updating should be identical to that on the encoding side.

As described above, the moving picture decoding apparatus according to the present embodiment prepares a reference filter identical to that on the encoding side, determines a correspondence relationship between the reference filter and a filter to be decoded, and then adds filter coefficients for the reference filter and a coefficient differences transmitted from the encoding side, thereby reconstructing the filter coefficients in the filter to be decoded. Accordingly, with the moving picture decoding apparatus, even where a filter to be decoded and a reference filter differ from each other in tap length, the filter coefficients in the filter to be decoded can be reconstructed using filter difference information that is smaller in quantity of code than the filter information.

The foregoing description was given using an example where there is only one piece of reference filter information. However, there may be more than one piece of reference filter information. For example, at least one of the properties (e.g., filter characteristics or tap length) of a filter to be decoded and the properties (e.g., slice type or quantization parameters) of an area where the filter to be decoded is used, may be set as a condition or conditions, and one of these may be selected for use from a plurality of pieces of reference filter information. In addition, where the plurality pieces of reference filter information are used, reference filter information that is independent from the condition mentioned above may also be provided.

### Third Embodiment

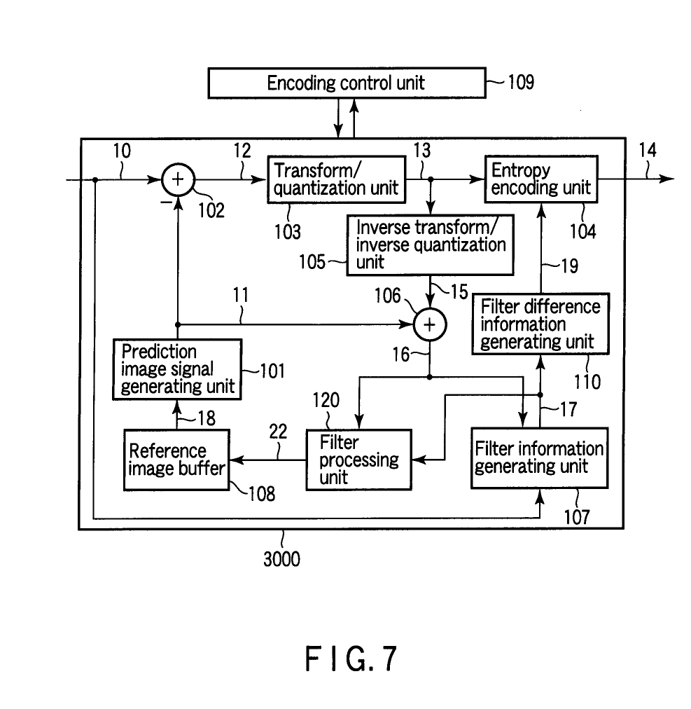

As shown in FIG. 7, a moving picture encoding apparatus according to a third embodiment performs so-called hybrid encoding, and is formed by replacing the moving picture encoding unit 1000 of the moving picture encoding apparatus in FIG. 1 with a moving picture encoding unit 3000. In the description below, parts in FIG. 7 identical to those in FIG. 1 are labeled with identical numbers, and descriptions are principally of the different parts.

The moving picture encoding unit 3000 is formed by adding a filter processing unit 120 to the moving picture encoding unit 1000 in FIG. 1.

The filter processing unit 120 performs a filter process for image reconstructing on a locally decoded image signal 16 from an adder 106, thereby obtaining a reconstructed image signal 22. The filter process performed by the filter processing unit 120 is identical to that performed on a decoding image signal on the decoding side, and a tap length and filter coefficients are specified by filter information 17 output from a filter information generating unit 107. The filter processing unit 120 inputs the reconstructed image signal 22 into a reference image buffer 108. The reconstructed image signal 22 from the filter processing unit 120 is temporarily stored in a reference image buffer 108 as a reference image signal 18, and is read by a prediction image signal generating unit 101 as necessary.

As described above, the moving picture encoding apparatus according to the present embodiment, which performs a so-called loop filter process, yields identical or similar effects to the moving picture encoding apparatus according to the first embodiment.

### Fourth Embodiment

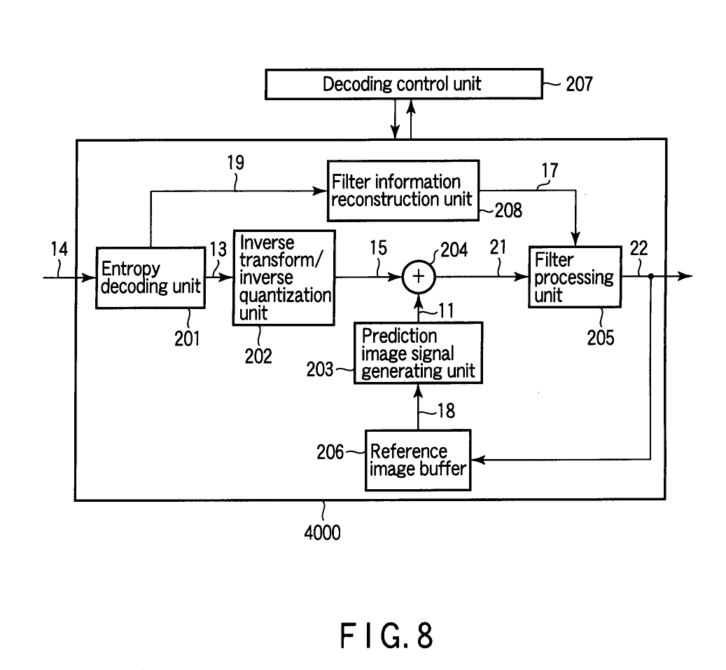

As shown in FIG. 8, a moving picture decoding apparatus according to a fourth embodiment decodes encoded data input from the moving picture encoding apparatus shown in FIG. 7, and is formed by replacing the moving picture decoding unit 2000 of the moving picture decoding apparatus in FIG. 4 with a moving picture decoding unit 4000. In the description below, parts in FIG. 8 identical to those in FIG. 4 are labeled with identical numbers, and descriptions are principally of the different parts.

In the moving picture decoding unit 2000, as described above, a decoded image signal 21 from an adder 204 is temporarily stored in a reference image buffer 206 as a reference image signal 18. On the other hand, in the moving picture decoding unit 4000, a reconstructed image signal 22 from a filter processing unit 205 is temporarily stored in a reference image buffer 206 as a reference image signal 18.

As described above, the moving picture decoding apparatus according to the present embodiment, which performs a so-called loop filter process, yields identical or similar effects to the moving picture decoding apparatus according to the second embodiment.

### Fifth Embodiment

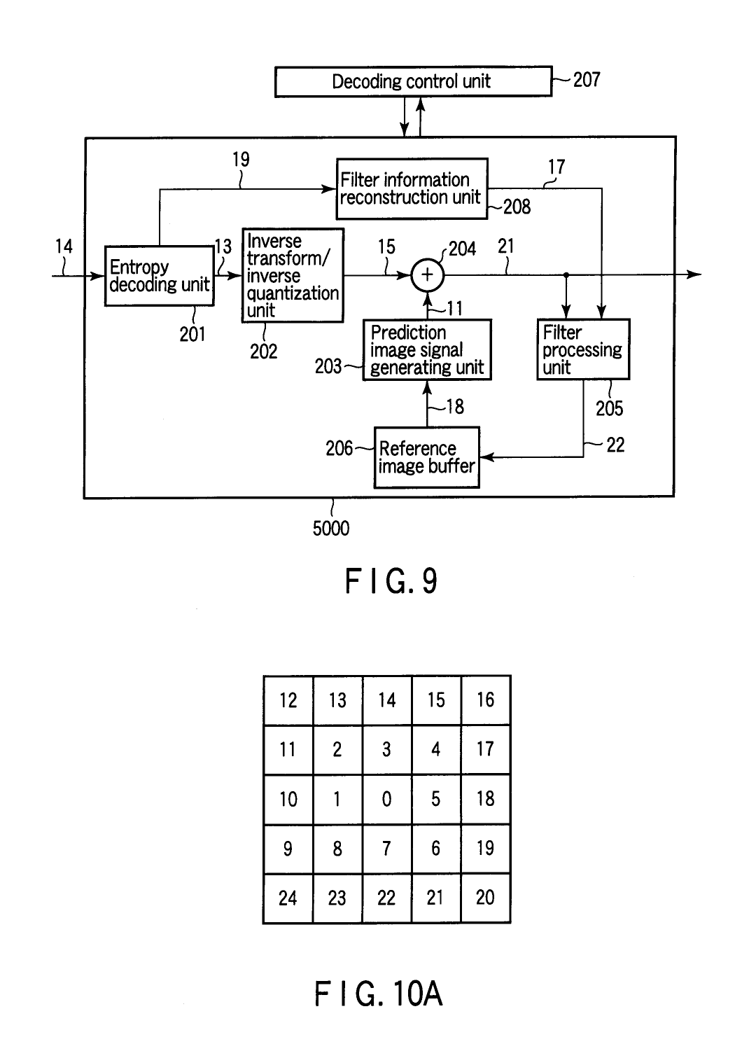

As shown in FIG. 9, a moving picture decoding apparatus according to the fifth embodiment decodes encoded data input from the moving picture encoding apparatus shown in FIG. 7, and is formed by replacing the moving picture decoding unit 2000 of the moving picture decoding apparatus in FIG. 4 with a moving picture decoding unit 5000. In the description below, parts in FIG. 8 identical to those in FIG. 4 are labeled with identical numbers, and descriptions are principally of the different parts.

In the moving picture decoding unit 2000, as described above, a decoded image signal 21 from an adder 204 is temporarily stored in a reference image buffer 206 as a reference image signal 18, and a reconstructed image signal 22 from a filter processing unit 205 is output to the outside. On the other hand, in the moving picture decoding unit 5000, a reconstructed image signal 22 from a filter processing unit 205 is temporarily stored in a reference image buffer 206 as a reference image signal 18, and a decoded image signal 21 from an adder 204 is output to outside.

As described above, the moving picture decoding apparatus according to the present embodiment, which performs a so-called loop filter process, yields identical or similar effects to the moving picture decoding apparatus according to the second embodiment.

### Sixth Embodiment

The moving picture encoding apparatuses according to the first and third embodiments described above generate filter difference information 19 by using the filter difference information generating unit 110 in FIG. 2. A moving picture encoding apparatus according to a sixth embodiment generates filter difference information 19 by using a filter difference information generating unit different from the filter difference information generating unit 110 in FIG. 2.

The filter difference generating unit 110 in FIG. 2 generates the filter difference information 19 including the filter coefficient differences between the filter to be encoded and the reference filter. The filter difference information generating unit 110 deals with a coefficient differences instead of the filter coefficients in a filter to be encoded, thereby decreasing the quantity of code generated. In this case, the filter coefficient in the reference filter is updated by an encoded filter coefficient and is, therefore, regarded as a predicted value for the filter coefficient in a target filter in the direction of time. That is, the effect of the filter difference information generating unit 110 in FIG. 2 with respect to a reduction in the quantity of code generated relative to the filter coefficients in a filter to be encoded relies on the temporal correlation of the filter to be encoded. Accordingly, the weaker the temporal relation between the filter to be encoded and the reference filter is, the less effectively the quantity of code generated will be reduced. If the filter coefficients in the filter to be encoded differ greatly from the filter coefficients in the reference filter, this may result in the generation of a larger quantity of code, compared to the case where the filter coefficients in the filter to be encoded are encoded. Additionally, in the case of so-called random access, in which decoding is started from an arbitrary time, filter information before the time to be accessed cannot be used. This may make it impossible to make predictions for filter coefficients in the direction of time.

Hence, the moving picture encoding apparatus according to the present embodiment switches, for filter coefficients, between prediction in the direction of time (hereinafter simply referred to as “temporal prediction mode”) and prediction in the direction of space (hereinafter simply referred to as “spatial prediction mode”), described below, as necessary. Specifically, the moving picture encoding apparatus according to the present embodiment adaptively uses the spatial prediction mode and, therefore, even where the temporal prediction mode is not suitable, this apparatus may effectively reduce the quantity of code generated based on the filter coefficient in the filter to be encoded.

The moving picture encoding apparatus according to the present embodiment can be formed by replacing the filter difference information generating unit 110 of the moving picture encoding apparatus in FIG. 1 or 7 with, for example, a filter difference information generating unit 310 shown in FIG. 11.

The filter difference information generating unit 310 includes a filter coefficient position correspondence relationship setting unit 111, a reference filter buffer 112, a reference filter updating unit 114, a temporal prediction mode filter coefficient difference calculating unit 115, a spatial prediction mode filter coefficient difference calculating unit 116, and a coefficient prediction mode control unit 117. Parts in FIG. 11 identical to those in FIG. 2 are labeled with identical numbers, and following descriptions are principally of the parts differing between FIGS. 11 and 2. The temporal prediction mode filter coefficient difference calculating unit 115 differs from the filter coefficient difference calculating unit 113 in name; however, it may be formed from substantially identical component.

The spatial prediction mode filter coefficient difference calculating unit 116 performs prediction in the direction of space on the filter coefficient in a filter to be encoded, and thereby generates filter difference information 19 including prediction error. The spatial prediction mode filter coefficient difference calculating unit 116 may use any existing or future spatial prediction technique.

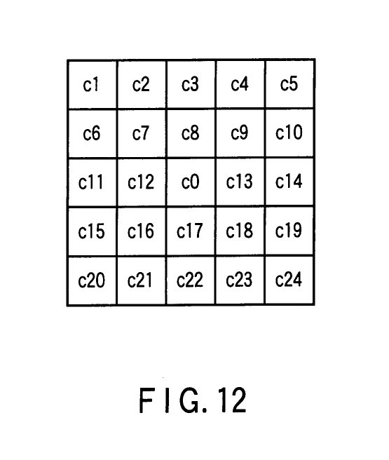

An example of a spatial prediction technique usable by the spatial prediction mode filter coefficient difference calculating unit 116 will now be described with reference to FIG. 12. Generally, the sum of the filter coefficients (in the case of FIG. 12, the sum of filter coefficients c0 to c24) does not vary very much. Accordingly, by estimating the sum of the filter coefficients as a fixed value, filter coefficients in any position (e.g., filter coefficient c0 in FIG. 12) can be predicted based on the sum of the filter coefficients in other positions (e.g., the sum of filter coefficients c1 to c24 in FIG. 12). A filter coefficient on which spatial prediction is performed may be chosen arbitrarily. However, since the filter coefficient in the central position (filter coefficient c0 in FIG. 12) is generally large, it is preferable, from the viewpoint of reducing the quantity of code generated, to perform spatial prediction on the filter coefficient in the center. A predicted value c0′ corresponding to the filter coefficient c0 in FIG. 12 can be derived from the sum S of the other filter coefficients c1 to c24 according to the following expression (2).

c0′=S−(c1+c2+ . . . c24) (2)

Where the sum (gain) of the filter coefficients is “1” and each filter coefficient is quantized using 8 bits, the sum S of the filter coefficients results in “256”. In addition, the sum S of the filter coefficients should be equal on the encoding and decoding sides. The spatial prediction mode filter coefficient difference calculating unit 116 generates a filter difference information 19 including a prediction error (=c0−c0′) for filter coefficient c0 and the other filter coefficients c1 to c24. Specifically, the spatial prediction mode filter coefficient difference calculating unit 116 replaces the filter coefficient c0 in the filter information 17 with the prediction error, thereby generating the filter difference information 19.

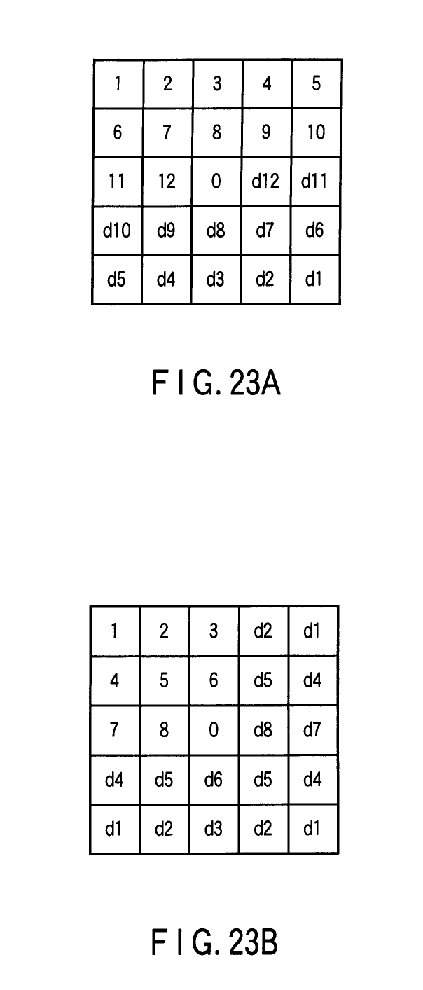

Spatial prediction techniques usable by the spatial prediction mode filter coefficient difference calculating unit 116 are not limited to that described above; however any technique using the spatial correlations between the filter coefficients may be applied. Referring to FIGS. 23A and 23B, other examples of the spatial prediction process will now be described. These spatial prediction processes may be used in combination with the spatial prediction process described above or other spatial prediction processes or may be used independently.

Generally, filter coefficients in point-symmetrical positions with respect to the position of the center often have equal or similar values. Therefore, as shown in FIG. 23A, the filter coefficients of indices 1 to 12 may be used as spatial predicted values for indices d1 to d12 respectively. Where such a spatial prediction process is used, prediction errors can be stored in the filter difference information 19 instead of the filter coefficients of the indices d1 to d12.

In addition, also, pieces of filter information vertically or horizontally symmetrical with respect to the position of the center often have equal or similar values. Therefore, as shown in FIG. 23B, the filter coefficients of the indeices 1 to 8 can be used as predicted values for the filter coefficients of the indeices d1 to d8 respectively. Also, where such a spatial prediction process is used, prediction errors can be stored in the filter difference information 19 instead of the filter coefficients of the indices d1 to d8.

The prediction mode control unit 117 makes a selection by adaptively switching between the filter difference information 19 generated by the temporal prediction mode filter coefficient difference calculating unit 115 and the filter difference information 19 generated by the spatial prediction mode filter coefficient difference calculating unit 116, and multiplexes and outputs coefficient prediction mode information for identifying a selected coefficient prediction mode with the filter difference information 19. A concrete example of a determination process of the coefficient prediction mode by the prediction mode control unit 117 is described below.

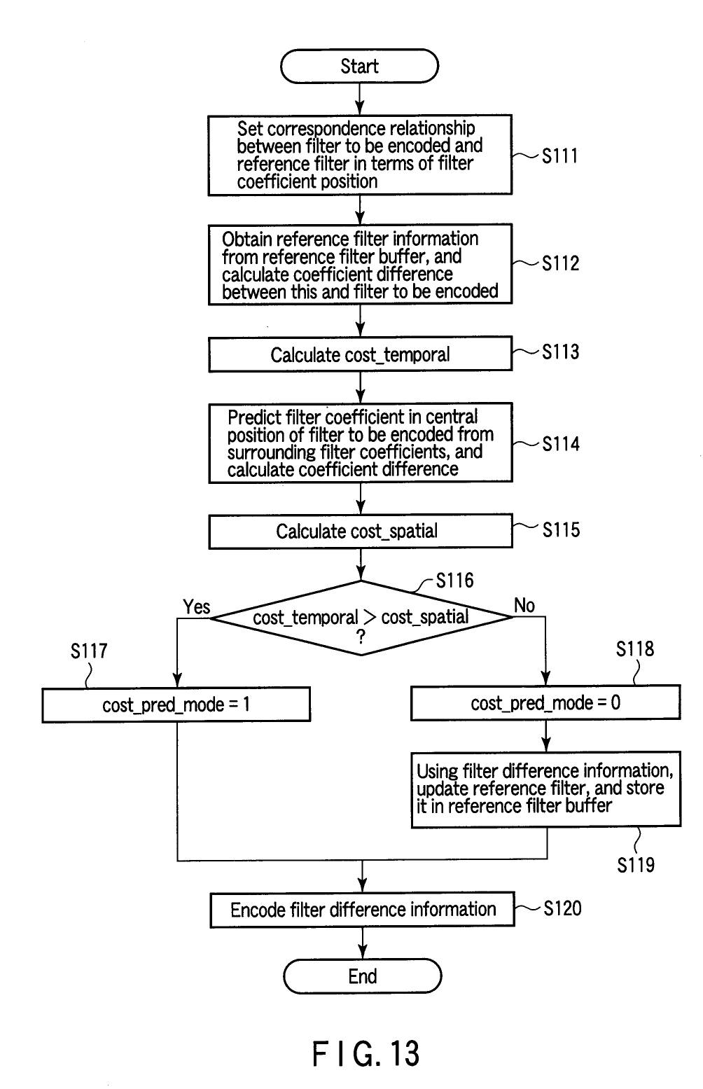

A process for generating the filter difference information 19 by a moving picture encoding apparatus according to the present embodiment will now be described with reference to FIG. 13. The process in FIG. 13 is started when the filter information generating unit 107 inputs the filter information 17 into the filter difference information generating unit 310.

In the example in FIG. 13, temporal prediction (steps S111 to S112) is performed prior to spatial prediction (step S114); however, they may be performed in reverse order or in parallel. In addition, the coefficient prediction mode control unit 117 determines a coefficient prediction mode based on encoding costs as described below. However, it may determine the coefficient prediction mode according to another arbitrary criterion. As described below, in step S116, a comparison is made between the temporal prediction process and spatial prediction process in terms of encoding costs calculated using the expression (1). However, since they merely differ in the method for calculating coefficient difference, comparing encoding costs is equivalent to comparing the quantities of code generated.

First, the filter coefficient position correspondence relationship setting unit 111 obtains a tap length included in the filter information 17 output from the filter information generating unit 107, and sets a correspondence relationship between a filter to be encoded and a reference filter in terms of the filter coefficient positions (step S111). The filter coefficient position correspondence relationship setting unit 111 converts each filter coefficient position of the filter to be encoded, to a first relative position from the center while converting each filter coefficient position of the reference filter to a second relative position from the center. Thereby the filter coefficient position correspondence relationship setting unit 111 sets a correspondence relationship such that the first and second relative positions coincide. The filter coefficient position correspondence relationship setting unit 111 then informs the temporal prediction mode filter coefficient difference calculating unit 115 and the reference filter updating unit 114 of this correspondence relationship.

Next, the temporal prediction mode filter coefficient difference calculating unit 115 reads reference filter information from the reference filter buffer 112, and subtracts each filter coefficient in the reference filter information from the corresponding filter coefficient in the filter information 17 according to the correspondence relationship set in step S111, thereby calculating each filter coefficient difference (step S112). Then, the temporal prediction mode filter coefficient difference calculating unit 115 replaces the filter coefficients in the filter information 17 with the filter coefficient differences, thereby generating the filter difference information 19. Subsequently, in accordance with the expression (1), the temporal prediction mode filter coefficient difference calculating unit 115 (alternatively, the coefficient prediction mode control unit 117 or other component may be used) calculates encoding cost cost_temporal for the filter difference information 19 obtained by the temporal prediction process (step S113).

The spatial prediction mode filter coefficient difference calculating unit 116 performs a spatial prediction process (e.g., calculation using expression (2)) for a part of the filter coefficients in a filter to be encoded (e.g., the filter coefficient in the central position), thereby calculating a prediction error as a coefficient difference (step S114). Then, the spatial prediction mode filter coefficient difference calculating unit 116 replaces the part of the filter coefficients in the filter information 17 (e.g., the filter coefficient in the central position) with the coefficient difference. Subsequently, in accordance with the expression (1), the spatial prediction mode filter coefficient difference calculating unit 116 (alternatively, the coefficient prediction mode control unit 117 or other component may be used) calculates encoding cost cost_spatial for the filter difference information 19 obtained by the spatial prediction process (step S115).

The coefficient prediction mode control unit 117 compares the encoding cost cost_temporal calculated in step 113 and the encoding cost cost_spatial calculated in step S115 (step S116). If the encoding cost cost_temporal is greater than the encoding cost cost_spatial, the process proceeds to step S117, otherwise, the process proceeds to step S118.

In step S117, the coefficient prediction mode control unit 117 substitutes a value “1” indicating the application of the spatial prediction mode into a flag coef_pred_mode, which serves as coefficient prediction mode information. Then, the coefficient prediction mode control unit 117 incorporate the coefficient prediction mode information into the filter difference information 19 obtained in the spatial prediction process (step S114), and outputs this to the entropy encoding unit 104. The process then proceeds to step S120.

In step S118, the coefficient prediction mode control unit 117 substitutes a value “0”, indicating application of the temporal prediction mode, into the flag coef_pred_mode. Then, the coefficient prediction mode control unit 117 outputs the filter difference information 19 obtained by the temporal prediction process (step S112) to the reference filter updating unit 114, and, in addition, incorporates the coefficient prediction mode information into the filter difference information 19 and outputs this to the entropy encoding unit 104. Next, in accordance with the correspondence relationship set in step S111, the reference filter updating unit 114 adds the filter coefficient differences calculated in step S112 to filter coefficients included in the reference filter information stored in the reference filter buffer 112, thereby updating the reference filter information (step S119). The process then proceeds to step S120. As described above, updating the reference filter information is not an essential process. However, even when the characteristics of the filter to be encoded gradually change, updating the reference filter frequently enables the characteristics of the reference filter to follow changes in the characteristics of the filter to be encoded. Accordingly, increases in coefficient differences and hence quantity of code generated can be suppressed.

In step S120, the entropy encoding unit 104 performs entropy encoding, such as Huffman coding or arithmetic coding, on the filter difference information 19, coefficient prediction mode information, and other coding parameters, which are input from the coefficient prediction mode control unit 117, and the quantized transform coefficient 13. The entropy encoding unit 104 outputs an encoded bit stream obtained by multiplexing the encoded data 14, and then the process terminates.

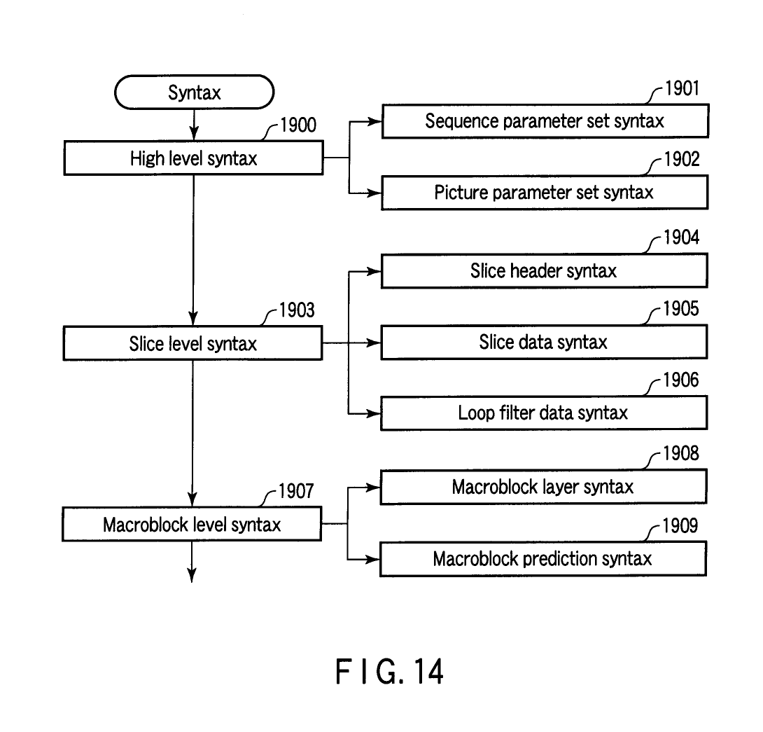

An example of a syntax structure used by the moving picture encoding apparatus according to the present embodiment will now be described with reference to FIG. 14. In the description below, the filter difference information 19 is transmitted to the decoding side in slice units. However, the filter difference information 19 may of course be transmitted to the decoding side at sequence, picture, or macroblock level.

As shown in FIG. 14, the syntax has a hierarchical structure of three ranks, which are a high level syntax 1900, a slice level syntax 1903, and a macroblock level syntax 1907 from highest to lowest.

The high level syntax 1900 includes a sequence parameter set syntax 1901 and a picture parameter set syntax 1902, and specifies information required in layers (e.g., sequence or picture) higher than slice.

The slice level syntax 1903 includes a slice header syntax 1904, a slice data syntax 1905, and a loop filter data syntax 1906, and specifies information required in slice units.

The macroblock level syntax 1907 includes a macroblock layer syntax 1908 and a macroblock prediction syntax 1909, and specifies information (e.g., quantized transform coefficient data, prediction mode information, and a motion vector) required in macroblock units.

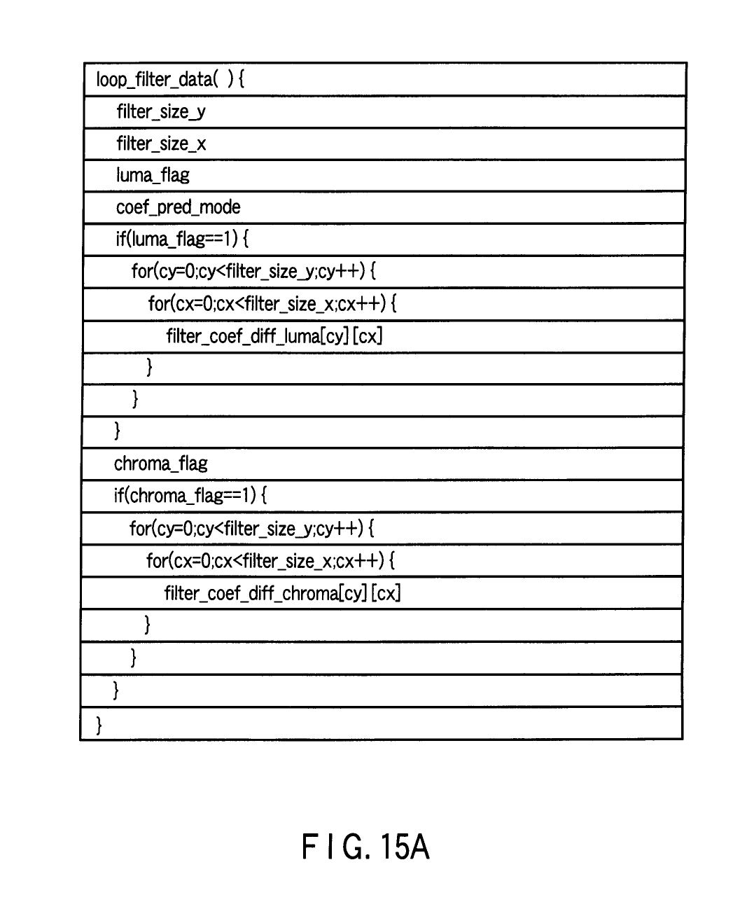

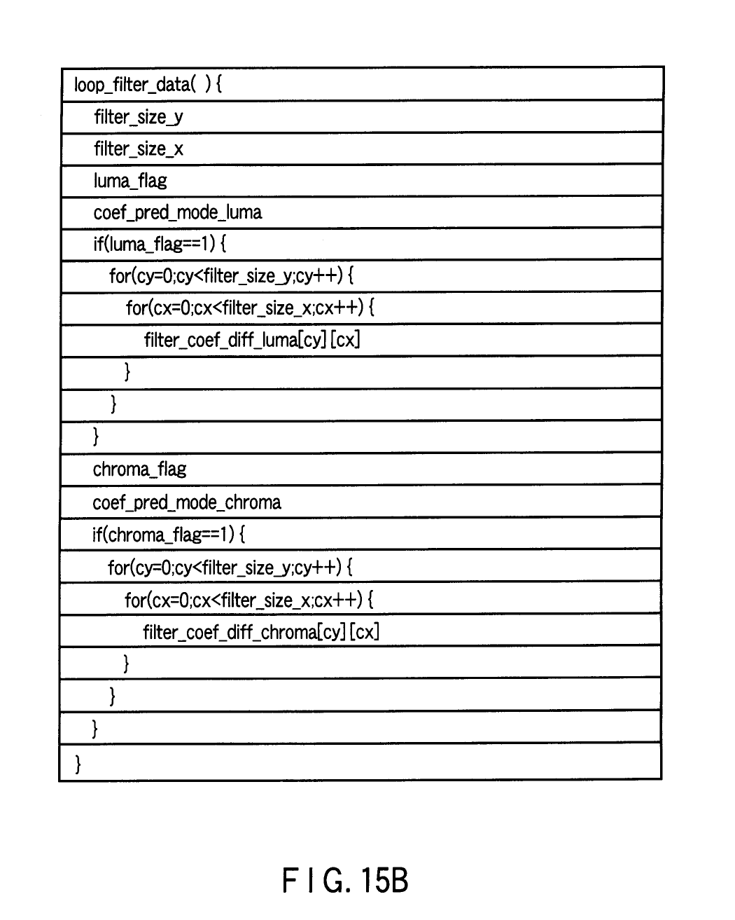

For example, in the loop filter data syntax 1906 described above, the filter difference information 19 is described in a form as shown in, for example, FIG. 15A. In FIG. 15A, a filter_size_x and a filter_size_y represent the size (i.e., tap length) in the horizontal direction (x direction) and the size (i.e., tap length) in the vertical direction (y direction), respectively, of a filter to be encoded. Luma_flag and chroma_flag represent flags indicating whether a luminance signal and chrominance signal, respectively, of an image, use a filter to be encoded. “1” indicates that a filter to be encoded is used, and “0” indicates that a filter to be encoded is not used. The coefficient prediction mode information coef_pred_mode has already been described above with reference to FIG. 13. Filter_coef_diff_luma[cy][cx] represents filter coefficient differences (with respect to filter coefficients used for a luminance signal) in a position identified by coordinates (cx, cy) (however, where a spatial prediction process is performed, the filter coefficients in a filter to be encoded may be used as is). Filter_coeff_diff_chroma[cy][cx] is filter coefficient differences (with respect to filter coefficients used for a chrominance signal) in a position identified by the coordinates (cx, cy) (however, where a spatial prediction process is performed, the filter coefficient in a filter to be encoded may be used as is).

In FIG. 15A, the identical filter difference information 19 is described for a plurality of chrominance signal components (i.e., the components are not distinguished from one another). However, individual filter difference information 19 may be described for each of the chrominance components. In addition, according to FIG. 15A, the filter difference information 19 used for a chrominance signal is always described. However, the filter difference information 19 used for a chrominance signal may be described only when a filter is used for a luminance signal (i.e., only when luma_flag=1, described above). Additionally, in FIG. 15A, coefficient prediction mode information is described as a flag coef_pred_mode that is common to the luminance and chrominance signals. However, the coefficient prediction mode information may be described as an independent flag. Where the coefficient prediction mode information is described as a flag independent of the luminance and chrominance signals, the filter difference information 19 may be described as shown in, for example, FIG. 15B (refer to flag coef_pred_mode_luma and flag coef_pred_mode_chroma).

As described above, the moving picture encoding apparatus according to the present embodiment adaptively performs not only temporal prediction but also spatial prediction on filter coefficients, thereby generating filter difference information. Accordingly, even where temporal prediction for filter coefficients is inappropriate, the moving picture encoding apparatus according to the present embodiment performs spatial prediction, thereby reducing the quantity of code generated based on the filter coefficient.

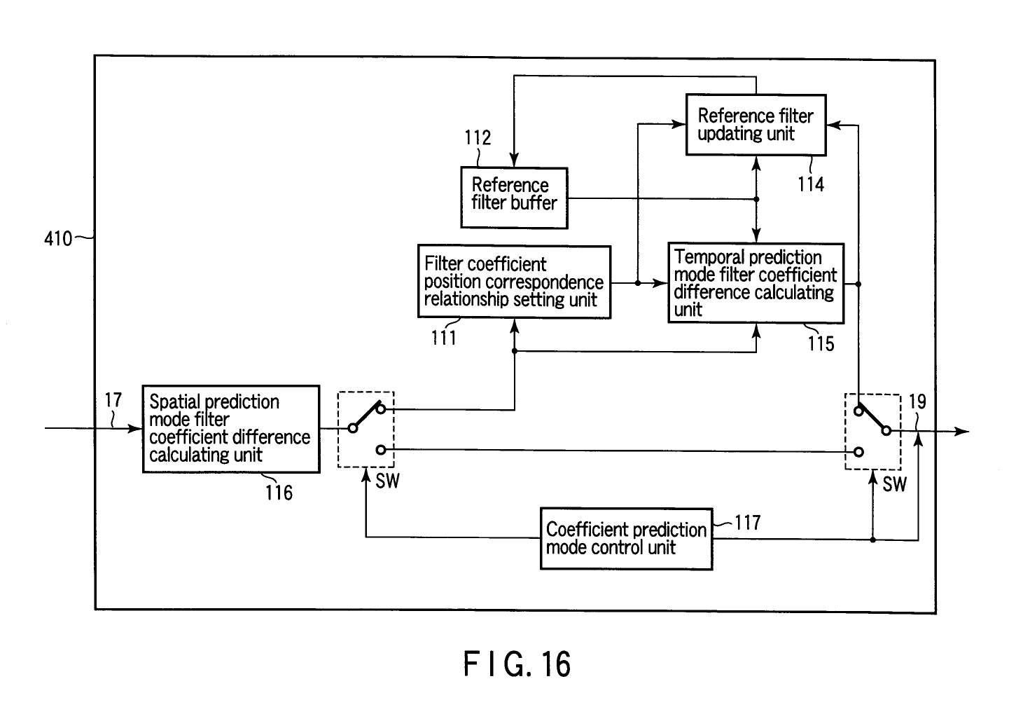

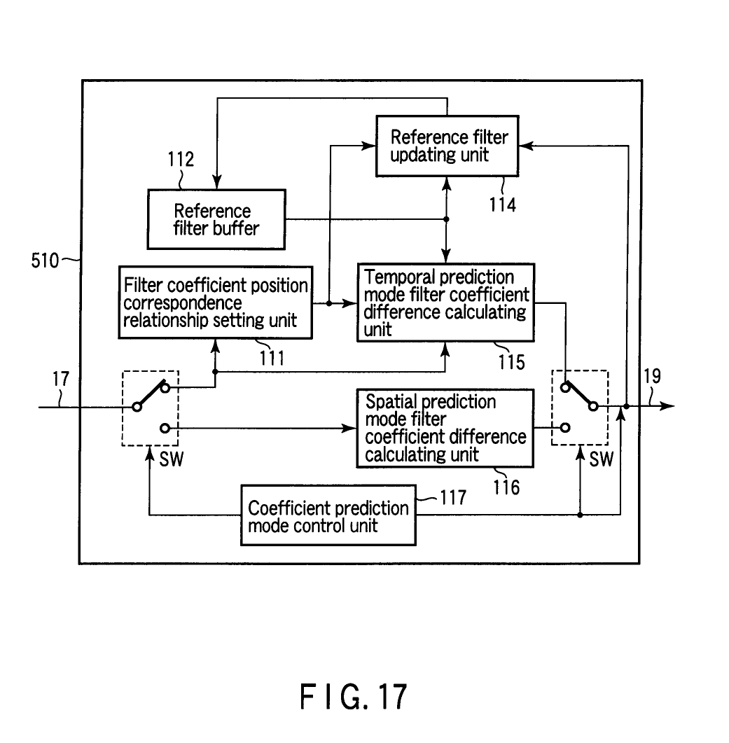

Incidentally, as describe above, the moving picture encoding apparatus according to the present embodiment can also be formed by replacing the filter difference information generating unit 110 of a moving picture encoding apparatus in FIG. 1 or 7 with one of the filter difference information generating units 410 and 510 shown in, for example, FIGS. 16 and 17 respectively.

The filter difference information generating unit 410 in FIG. 16 differs from the filter difference information generating unit 310 in FIG. 11 in terms of the location of the spatial prediction mode filter coefficient difference calculating unit 116. Specifically, in the filter difference information generating unit 410, the spatial prediction process is used regardless of whether the temporal prediction process is used or not. For example, the spatial prediction mode filter coefficient difference calculating unit 116 performs spatial prediction on a filter coefficient in the central position based on the estimated value of the sum of the filter coefficients and filter coefficients in other positions and the coefficient prediction mode control unit 117 adaptively determines whether or not the temporal prediction for the filter coefficients in other positions is used. That is, the filter difference information 19 generated by the filter difference information generating unit 410 may include both a spatial prediction error and a temporal prediction error.

The filter difference information generating unit 510 in FIG. 17 differs from the filter difference information generating unit 310 in FIG. 11 in the following respect: the reference filter updating unit 114 may update the filter coefficient for the reference filter by use of filter difference information 19 based on spatial prediction in addition to filter difference information 19 based on temporal prediction.

In addition, as described above, a plurality of reference filters may be prepared for the filter difference generating units 410 and 510 as well. For example, at least one of the properties (e.g., filter characteristics or tap length) of a filter to be encoded and the properties (e.g., slice type or quantization parameters) of an area where the filter to be encoded is used, may be set as a condition/conditions, and one of these may be selected for use from a plurality of pieces of reference filter information. In addition, where a plurality of pieces of reference filter information are used, reference filter information that is independent from the condition mentioned above may also be provided. Filter coefficients included in reference filter information that is independent from the above-mentioned condition may be commonly used as an initial value for filter coefficients included in reference filter information that dependent on the condition.

A description will now be given of several preferred examples of the timing of update of the filter coefficients in a reference filter by the filter difference information generating unit 510 by use of the filter difference information 19 based on spatial prediction.

From the viewpoints of error resilience (i.e., the prevention of propagation of error in the direction of time) and random access, the coefficient prediction mode control unit 117 may always select the filter difference information 19 based on spatial prediction with specific timing (in the case where the area in which a filter to be encoded is used is, for example, IDR slice or I slice), and then the reference filter updating unit 114 may update a reference filter. The updating of this reference filter corresponds to the initialization (or refreshing) of the reference filter.

Where a plurality of reference filters are prepared, some of the reference filters (reference filters used in IDR slice or I slice) may have been initialized whereas the other reference filters (reference filter used in P slice, B slice, or the like, or a reference filter different in tap length from the initialized reference filter) may not have been initialized. Therefore, when each reference filter is first selected according to the condition, the coefficient prediction mode control unit 117 may always selects the filter difference information 19 based on spatial prediction, and the reference filter updating unit 114 may update (i.e., initialize) the reference filter. For example, the following rule may be defined: when the spatial prediction mode is selected for a filter to be encoded, which is used in, for example, IDR slice, I slice, or the like, each of the other reference filters must be initialized when first selected in accordance with the condition. It is known that where reference filters are initialized according to such a rule, spatial prediction must be selected in order to reconstruct the filter information 17 on the decoding side. Therefore, coefficient prediction mode information (e.g., flag pred_coef_mode) may be omitted from the filter difference information 19.

The foregoing rule is simple. However, this rule results in a situation in which each time the spatial prediction mode is selected for a filter to be encoded, which is used in IDR slice or I slice, the other reference filters are imposed on the initialization. That is, even where the quantity of code generated can be reduced by selecting the temporal prediction mode for the reference filter rather than the spatial prediction mode, the spatial prediction mode must be selected. Therefore, as expansion of this rule, switching information indicating whether the other reference filters need to be initialized may be added to the filter difference information 19.

Additionally, initialization of other reference filters resulting from the selection of the spatial prediction mode for the filter to be encoded, which is used in IDR slice or I slice, may be achieved by actually performing spatial prediction. Alternatively, this initialization may be achieved by performing temporal prediction through re-using the filter to be encoded, which is used in IDR slice or I slice, as a reference filter.

As described above, initial values for filter coefficients included in reference filter information are common to the encoding and decoding sides. Therefore, by substituting the initial value with filter coefficients for the reference filter, the reference filter may be initialized.

Where the reference filter is initialized in the foregoing manner, the coefficient prediction mode controlling unit 117 may obtain the filter information 17 and information (e.g., slice information) about an area where a filter to be encoded is used, and control the reference filter updating unit 114. It is a matter of course that the timing of the initialization of the reference filter on the encoding and decoding sides should coincide.

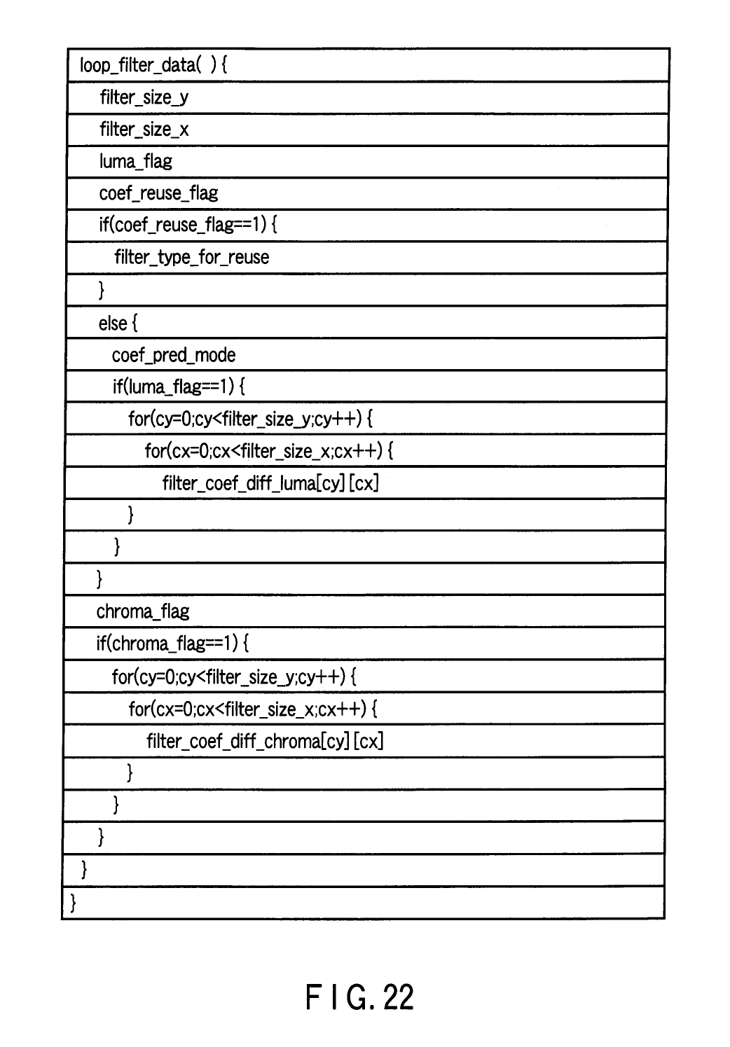

Further, the first and third embodiments reduce the quantity of code generated based on filter coefficients by generating the filter difference information 19 by use of the prediction error for filter coefficients (i.e., coefficient differences) instead of the filter coefficients in a filter to be encoded. However, where the temporal prediction mode is selected, a reference filter is inferior to an optimally designed filter in the effect of image quality improvement, but may be superior to it in the balance between quantity of code generated and image quality (e.g., in encoding cost). In such a case, filter coefficients in a reference filter on the decoding side may be directly used as filter coefficients in a filter to be decoded (hereinafter referred to as “reuse mode”). Where this reuse mode is selected, the coefficient prediction mode control unit 117 replace information about identifying reference filters, whose filter coefficients (when a plurality of reference filters are prepared) are all equal to those in a filter to be encoded, with the prediction errors. Thus, using this result, the control unit 117 generates the filter difference information 19.

Where re-use mode can be selected, the filter difference information 19 is described in a form as shown in FIG. 22. In FIG. 22, coef_reuse_flag represents whether the reuse mode is used or not. If the reuse mode is used, “1” is set, and otherwise, “0” is set. Filter_type_for_reuse represents an index for identifying a reference filter to be used in reuse mode. However, where there is only one reference filter, the index filter_type_for_reuse is unnecessary. Flag coef_reuse_flag and index filter_type_for_reuse may be independently set for a luminance signal and a chrominance signal.

### Seventh Embodiment

Using the filter information reconstruction unit 208 in FIG. 5, the moving picture encoding apparatuses according to the second, fourth, and fifth embodiments reconstruct the filter information 17. Using a filter information reconstruction unit different from the filter information reconstruction unit 208 in FIG. 5, a moving picture decoding apparatus according to a seventh embodiment reconstructs filter information 17.

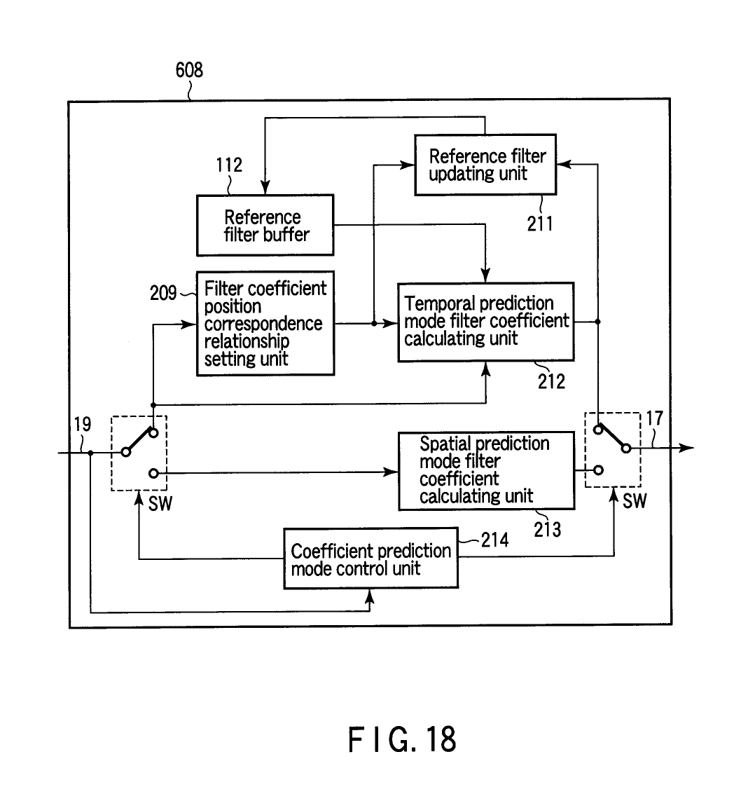

The moving picture decoding apparatus according to the present embodiment decodes encoded data output from the moving picture encoding apparatus according to the sixth embodiment described above. The moving picture decoding apparatus according to the present embodiment can be formed by replacing the filter information reconstruction unit 208 in the moving picture encoding apparatus in FIG. 4, 8, or 9 with, for example, a filter information reconstruction unit 608 shown in FIG. 18.

The filter information reconstruction unit 608 reconstructs the filter information 17 from filter difference information 19 generated by the filter information generating unit 310 described above. The filter information reconstruction unit 608 includes a filter coefficient position correspondence relationship setting unit 209, a reference filter updating unit 211, a reference filter buffer 112, a temporal prediction mode filter coefficient calculating unit 212, a spatial prediction mode filter coefficient calculating unit 213, and a coefficient prediction mode control unit 214. Parts in FIG. 18 identical to those in FIG. 5 are labeled with identical numbers, and descriptions are principally of the parts that differ in FIGS. 18 and 5. The temporal prediction mode filter coefficient calculating unit 212 differs from the filter coefficient calculating unit 210 in name; however, substantially identical components can be used.

When the filter difference information 19 is input, the spatial prediction mode filter coefficient calculating unit 213 performs spatial prediction identical to that on the encoding side, and obtains a predicted value for a part (e.g., the filter coefficient in the central position) of the filter coefficients in a filter to be decoded. Then, the spatial prediction mode filter coefficient calculating unit 213 adds the predicted value and the corresponding prediction error (included in the filter difference information 19), thereby reconstructing the filter coefficients in the filter to be decoded. The spatial prediction mode filter coefficient calculating unit 213 replaces the prediction errors in the filter difference information 19 with the reconstructed filter coefficients, finally obtaining the filter information 17.

The coefficient prediction mode control unit 214 identifies a coefficient prediction mode used on the encoding side by referring to coefficient prediction mode information included in the filter difference information 19. Then, in order to use a reconstructing process (i.e., a calculating process for filter coefficients for a filter to be decoded) corresponding to the identified coefficient prediction mode, the control unit 214 switches the place to which the filter difference information 19 is output.

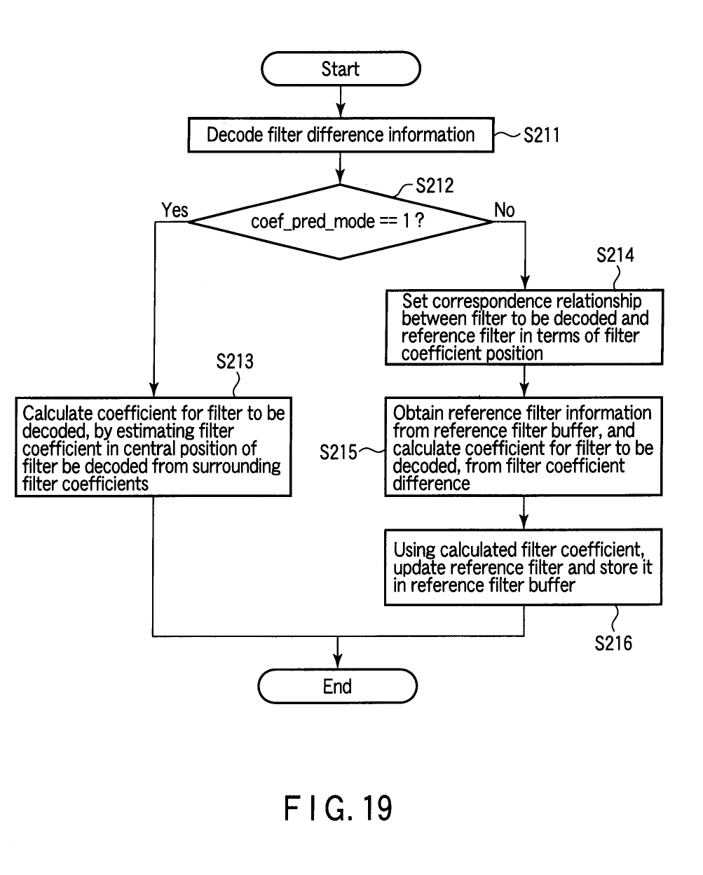

Referring to FIG. 19, a reconstructing process for the filter information 17 in the moving picture decoding apparatus according to the present embodiment will now be described.

First, the entropy decoding unit 201 decodes encoded data 14, and obtains the filter difference information 19, other coding parameters, and quantized transform coefficient 13 (step S211). The entropy decoding unit 201 inputs the quantized transform coefficient 13 into the inverse transform/inverse quantization unit 202 and inputs the filter difference information 19 into the filter information reconstruction unit 608. Then, the process proceeds to step S212.

In step S212, the coefficient prediction mode control unit 214 refers to coefficient prediction mode information included in the filter difference information 19, and determines the place to which the filter difference 19 is output. For example, if the flag coef_pred_mode described above is “1,” the filter difference information 19 is output to the spatial prediction mode filter coefficient calculating unit 213. Then, the process proceeds to step S213. Otherwise, the filter difference information 19 is output to the filter coefficient position correspondence relationship setting unit 209. The process then proceeds to step S214.

In step S213, the spatial prediction mode filter coefficient calculating unit 213 calculates a predicted value by performing a spatial prediction process (e.g., calculation using expression (2)) for a part of the filter coefficients in a filter to be decoded (e.g., the filter coefficient in the central position), which are included in the filter difference information 19. Then, the spatial prediction mode filter coefficient calculating unit 213 adds the spatial predicted value to the coefficient difference (i.e., prediction error) included in the filter difference information 19 and thus reconstructs a filter coefficient for a filter to be decoded. The spatial prediction mode filter coefficient calculating unit 213 replaces the prediction error included in the filter difference information 19 with the reconstructed filter coefficient, and inputs this into the filter processing unit 205 as the filter information 17. The process then terminates.

In step S214, the filter coefficient position correspondence relationship setting unit 209 obtains the tap length included in the filter difference information 19 output from the entropy decoding unit 201, and sets the correspondence relationship between the filter to be decoded and the reference filter in terms of filter coefficient positions. The filter coefficient position correspondence relationship setting unit 209 converts each filter coefficient position of the filter to be decoded to a first relative position from the center while converting each filter coefficient position of the reference filter to a second relative position from the center. Thereby the filter coefficient position correspondence relationship setting unit 209 sets a correspondence relationship such that the first and second relative positions coincide. The filter coefficient position correspondence relationship setting unit 209 then informs the temporal prediction mode filter coefficient calculating unit 212 and the reference filter updating unit 211 of this correspondence relationship.

Next, the temporal prediction mode filter coefficient calculating unit 212 reads reference filter information from the reference filter buffer 112, and adds each filter coefficient in the filter difference information 19 and the corresponding filter coefficient in the reference filter information in accordance with the correspondence relationship set in step S214, thereby reconstructing filter coefficients included in the filter information 17 generated on the encoding side (step S215). Then, this temporal prediction mode filter coefficient calculating unit 212 replaces the filter coefficients in the filter difference information 19 with the corresponding calculated filter coefficients, and inputs this to the filter processing unit 205 and the reference updating unit 211 as the filter information 17.

Subsequently, in accordance with the correspondence relationship set in step S214, the reference filter updating unit 211 replaces each filter coefficient included in the reference filter information stored in the reference filter buffer 112 with the corresponding filter coefficient calculated in step S215, thereby updating reference filter information (step S216). The process then terminates. As described above, updating the reference filter information is not an essential process. However, the timing of the updating on the decoding side should coincide with that on the encoding side.

As described above, in accordance with the coefficient prediction mode identical to that on the encoding side, the moving picture decoding apparatus according to the present embodiment reconstructs each filter coefficient in a filter to be decoded from the corresponding coefficient difference (i.e., a prediction error) included in the filter difference information. Therefore, using filter difference information that is smaller in quantity of code generated than the filter information, the moving picture decoding apparatus according to the present embodiment can reconstruct filter coefficients in the filter to be decoded.

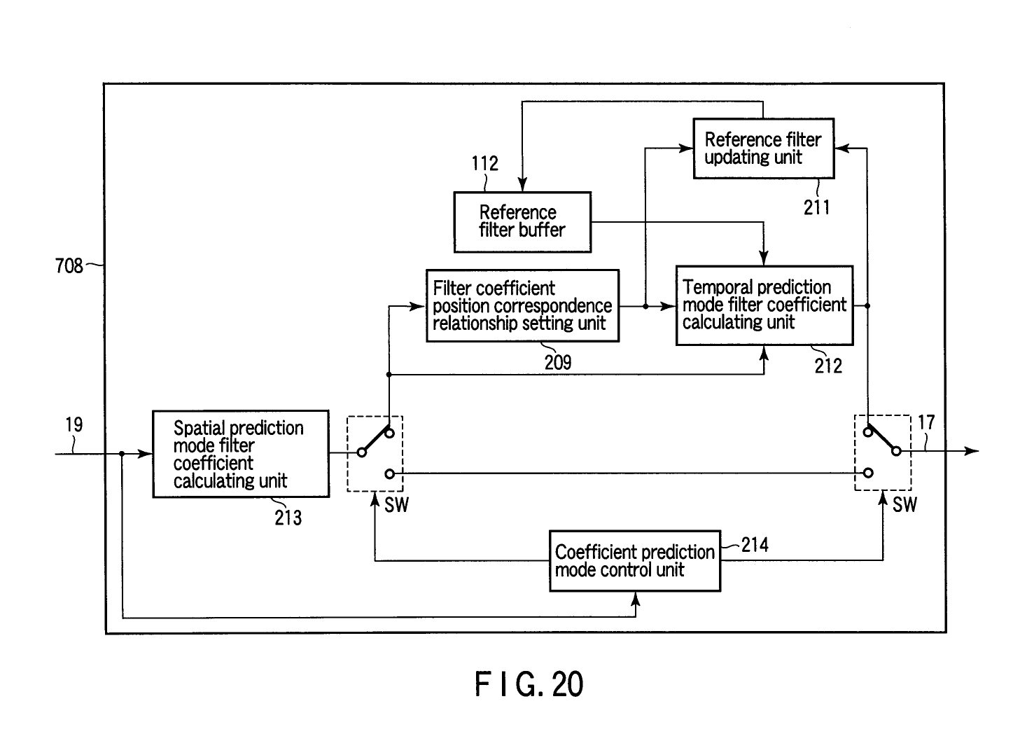

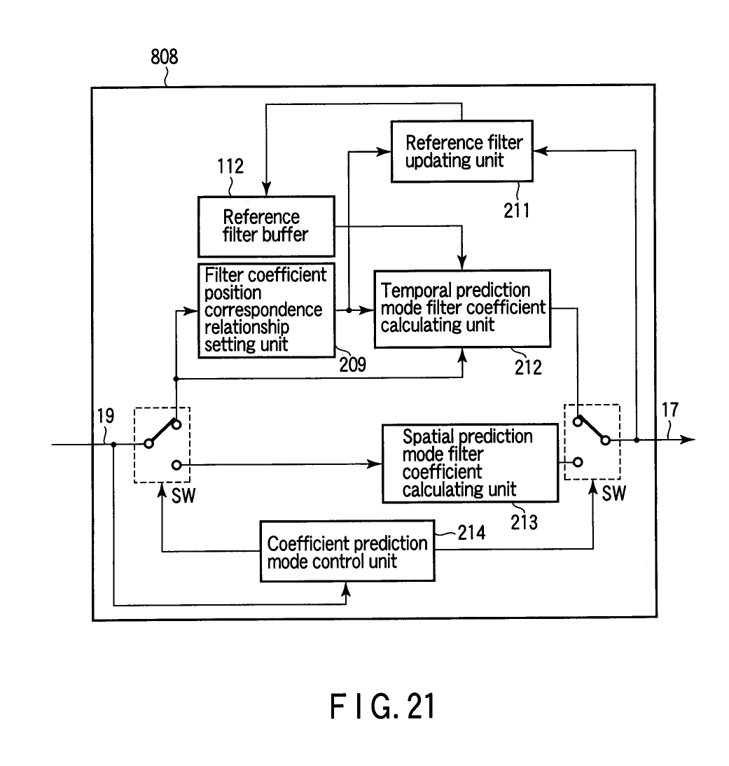

Incidentally, as described above, the moving picture decoding apparatus according to the present embodiment can also be formed by replacing the filter information reconstruction unit 208 in the moving picture decoding apparatus in FIG. 4, 8, or 9 with, for example, a filter information reconstruction unit 708 in FIG. 20 or a filter information reconstruction unit 808 in FIG. 21.

The filter information reconstruction unit 708 in FIG. 20 differs from the filter information reconstruction unit 608 in FIG. 18 in terms of the location of the spatial prediction mode filter coefficient calculating unit 213. The filter information reconstruction unit 708 reconstructs filter information 17 from the filter difference information 19 generated using filter difference information generating unit 410 in FIG. 16.

The filter information reconstruction unit 808 in FIG. 21 differs from the filter information reconstruction unit 608 in FIG. 18 in the following respect: a reference filter updating unit 211 updates filter coefficients in the reference filter by using filter information 17 based on spatial prediction in addition to filter information 17 based on temporal prediction. The filter information reconstruction unit 808 reconstructs the filter information 17 from the filter difference information 19 generated by the filter difference information generating unit 510 in FIG. 17.

In addition, where the reference filter is initialized with specific timing from the viewpoints of error resilience and random access on the encoding side, the filter information reconstruction units 608, 708, and 808 initialize the reference filter with the same timing and in the same form. Where the reuse mode is used on the encoding side, the filter information reconstruction units 608, 708, and 808 reconstruct filter information 17 by use of filter coefficients in an appropriate reference filter.

In each of the foregoing embodiments, a description was given concerning a reduction in quantity of code generated based on filter information in a post-filter process or loop filter process. However, as described in each embodiment, even in a filter process in which there is the possibility of transmitting filter information to the decoding side from the encoding side, as in an interpolation filter process or a filter process for a reference image signal, the quantity of code generated based on the filter information can be reduced.

The moving picture encoding apparatus and moving picture decoding apparatus according to each embodiment can be realized by using, for example, a general-purpose computer as basic hardware. Specifically, causing a processor incorporated in the computer to run a program makes it possible to realize the components described above: the prediction image signal generating unit 101, the subtractor 102, the transform/quantization unit 103, the entropy encoding unit 104, the inverse transform/inverse quantization unit 105, the adder 106, the filter information generating unit 107, the encoding control unit 109, the filter difference information generating units 110, 310, 410, and 510, the filter coefficient position correspondence relationship setting unit 111, the filter coefficient difference calculating unit 113, the reference filter updating unit 114, the temporal prediction mode filter coefficient difference calculating unit 115, the spatial prediction mode filter coefficient difference calculating unit 116, the coefficient prediction mode control unit 117, the entropy decoding unit 201, the inverse transform/inverse quantization unit 202, the prediction image signal generating unit 203, the adder 204, the filter processing unit 205, the decoding control unit 207, the filter information reconstruction units 208, 608, 708, and 808, the filter coefficient position correspondence relationship setting unit 209, the filter coefficient calculating unit 210, the reference filter updating unit 211, the temporal prediction mode filter coefficient calculating unit 212, the spatial prediction mode filter coefficient calculating unit 213, and the coefficient prediction mode control unit 214. In this case, the moving picture encoding apparatus and moving picture decoding apparatus according to each embodiment may be realized by installing the program in the computer in advance. Alternatively, these apparatuses may be realized by storing the program in a recording medium such as a CD-ROM or distributing the program via a network and then installing the program in the computer as needed. In addition, the reference image buffer 108, the reference filter buffer 112, and the reference image buffer 206 can be realized by using, as needed, a recording medium, such as a memory, hard disk or CD-R, CD-RW, DVD-RAM, or DVD-R, which is incorporated in the computer or externally attached to the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving picture encoding method comprising:
deriving a target filter to be used for a decoded image of a target image to be encoded;
setting a correspondence relationship between a target filter coefficient in the target filter and a reference filter coefficient in a reference filter in accordance with tap length of the target filter and tap length of the reference filter;
deriving a coefficient difference between the target filter coefficient and the reference filter coefficient in accordance with the correspondence relationship; and
encoding target filter information including the tap length of the target filter and the coefficient difference.

2. The method according to claim 1, further comprising updating the reference filter by use of the reference filter coefficient and the coefficient difference.

3. The method according to claim 1, further comprising, deriving, by use of the target filter for the decoded image of the target image, a reference image for an image to be encoded after the target image.

4. The method according to claim 1, wherein the correspondence relationship is set such that a relative position of the target filter coefficient from a center of the target filter coincide with a relative position of the reference filter coefficient from a center of the reference filter.

5. The method according to claim 1, wherein the correspondence relationship is set such that the reference filter is selected from a plurality of reference filter candidates based on at least one condition of properties of the target filter and properties of an area where the target filter is used.

6. The method according to claim 5, wherein the properties of the area where the target filter is used include at least one of a slice type and a quantization parameter in the area where the target filter is used.

7. The method according to claim 5, further comprising updating the reference filter by use of the reference filter coefficient and the coefficient difference, and
wherein the plurality of reference filter candidates include a first reference filter candidate that is independent from the condition and a second reference filter candidate that is dependent on the condition, and wherein when each reference filter included in the second reference filter candidate is first selected in accordance with the condition, a filter coefficient in the first reference filter candidate is used as an initial value.

8. The method according to claim 5, wherein the properties of the target filter include the tap length of the target filter.

9. A moving picture encoding method comprising:
deriving a target filter to be used for a decoded image of a target image to be encoded;
deriving a target coefficient difference by use of a temporal prediction mode or a spatial predication mode, wherein the temporal prediction mode includes setting a correspondence relationship between a target filter coefficient in the target filter and a reference filter coefficient in a reference filter in accordance with tap length of the target filter and tap length of the reference filer, and deriving a temporal coefficient difference between the target filter coefficient and the reference filter coefficient in accordance with the correspondence relationship, and wherein the spatial prediction mode includes predicting a predicted value for a part of coefficient in the target filter coefficient based on other coefficient in the target filter coefficient and deriving a spatial coefficient difference between the part of coefficient and the predicted value; and
encoding target filter information including the tap length of the target filter, prediction mode information indicating a prediction mode for the target coefficient difference, and the target coefficient difference.

10. The method according to claim 9, wherein when the prediction mode information indicates the temporal prediction mode, the target coefficient difference in identical position as the part of coefficient in the target filter coefficient is the spatial coefficient difference, and the target coefficient difference in identical position as the other coefficient in the target filter coefficient is the temporal coefficient difference.

11. The method according to claim 9, further comprising updating the reference filter by the target filter coefficient.

12. The method according to claim 9, the prediction mode information is independently set in terms of a luminance signal and a chrominance signal.

13. The method according to claim 9, further comprising setting reuse information indicating whether the reference filter coefficient can be used as the target filter coefficient, wherein the target filer information further includes the reuse information.

14. A moving picture decoding method comprising:
decoding encoded data into which target filter information is encoded, wherein the target filter information includes tap length of a target filter, a coefficient difference between a target filter coefficient in the target filter and a reference filter coefficient in a reference filer;
setting a correspondence relationship between the coefficient difference and the reference filter coefficient in accordance with the tap length of the target filter and the tap length of the reference filter; and
calculating the target filter coefficient, by adding the coefficient difference and the reference filter coefficient in accordance with the correspondence relationship.

15. The method according to claim 14, further comprising updating the reference filter by use of the target filter coefficient.

16. The method according to claim 14, further comprising deriving, by use of the target filter for a decoded image, a reference image for an image to be decoded after the decoded image.

17. The method according to claim 14, wherein the correspondence relationship is set such that a relative position of the coefficient difference from a center of the target filter coincide with a relative position of the reference filter coefficient from a center of the reference filter.

18. The method according to claim 14,
wherein the correspondence relationship is set such that the reference filter is selected from a plurality of reference filter candidates based on at least one condition of properties of the target filter and properties of an area where the target filter is used.

19. The method according to claim 18,
wherein the properties of the area where the target filter is used include at least one of a slice type and a quantization parameter in the area where the target filter is used.

20. The method according to claim 18, further comprising updating the reference filter by use of the target filter coefficient, and
wherein the plurality of reference filter candidates includes a first reference filter candidate that is independent from the condition and a second reference filter candidate that is dependent on the condition, and wherein when each reference filter included in the second reference filter candidate is first selected in accordance with the condition, a filter coefficient in the first reference filter candidate is used as an initial value.

21. The method according to claim 18, wherein the properties of the target filter include the tap length of the target filter.

22. A moving picture decoding method comprising:
decoding encoded data into which target filter information is encoded, wherein the target filter information includes tap length of a target filter, a prediction mode information indicating a prediction mode used for the target filter, and a target coefficient difference indicating prediction error for a target filter coefficient in the target filter;
reconstructing the target filter coefficient when the prediction mode information indicates a temporal prediction mode, by setting a correspondence relationship between the target coefficient difference and a reference filter coefficient in a reference filter in accordance with the tap length of the target filter and tap length of the reference filter, and adding the target coefficient difference and the reference filter coefficient in accordance with the correspondence relationship; and
reconstructing the target filter coefficient when the prediction mode information indicates a spatial prediction mode, by predicting a part of the target filter coefficient based on other target filter coefficient and adding the target coefficient difference.

23. The method according to claim 22, wherein when the prediction mode information indicates the temporal prediction mode, the target coefficient difference in identical position as the other target filter coefficient and the reference filter coefficient is added in accordance with the correspondence relationship to reconstruct the other target filter coefficient, and wherein the part of the target filter coefficient is predicted based on the other target filter coefficient, and added to the target coefficient difference in identical position to reconstruct the part of the target filter coefficient.

24. The method according to claim 22, further comprising updating the reference filter by use of the target filter coefficient.

25. The method according to claim 22, wherein the prediction mode information is independently set in terms of luminance signal and chrominance signal.

26. The method according to claim 22, wherein the target filter information further includes reuse information indicating whether the reference filter coefficient can be used as the target filter coefficient, and wherein when the reuse information indicates that the reference filter coefficient can be used as the target filter coefficient, the reference filter coefficient is used as the target filter coefficient.
